(19) United States
(12) Patent Application Publication
(10) Pub. No.: US 2010/0126180 A1
(43) Pub. Date: May 27, 2010

(54) SEPARATION OF CARBON DIOXIDE AND HYDROGEN

(76) Inventors: Jonathan Alec Forsyth, Berkshire (GB); Roger Neil Harper, Surrey (GB); Antonie Pieter Hinderink, Etten-Leur (NL); Badrul Huda, Surrey (NL); Evert Van Der Pol, Schijndel (NL)

Correspondence Address: NIXON & VANDERHYE, PC, 901 NORTH GLEBE ROAD, 11TH FLOOR, ARLINGTON, VA, 22203, US

(21) Appl. No.: 12/452,819

(22) PCT Filed: Jul. 8, 2008
(86) PCT No.: PCT/GB2008/002335

§ 371 Date: Jan. 25, 2010

(30) Foreign Application Priority Data
Jul. 25, 2007 (EP) 07252941.5

(51) Int. Cl. F25J 3/06; F02C 3/28

(52) U.S. Cl. 60/780; 62/617

(57) ABSTRACT

This invention relates to the recovery of carbon dioxide (26) and hydrogen (3,24) concentrated form from shifted a synthesis gas stream comprising hydrogen and carbon dioxide thereby generating a carbon dioxide stream that is sequestered or used for enhanced oil recovery and a hydrogen stream that is used as fuel for a power plant thereby generation electricity. In the process of the present invention a shifted synthesis gas stream is fed to a hydrogen selective membrane separation unit (M101) at a pressure of at least 50 bar gauge and the hydrogen rich permeate stream (3) is fed directly to the combustor of a gas turbine without any requirement to re-compress the hydrogen. The residual gas stream (carbon dioxide enriched stream) from the membrane separation unit is cooled using at least one, preferably, at least two external refrigeration stages (E-101, E-102, E-103, E-104) such that the hydrogen containing offgas (24) is also obtained at above the operating pressure of the combustor of the gas turbine.

This invention relates to the recovery of carbon dioxide and hydrogen in a concentrated form from a synthesis gas stream comprising hydrogen and carbon dioxide thereby generating a carbon dioxide stream that may be sequestered or used for enhanced oil recovery and a hydrogen stream that may be used as fuel for a power plant thereby generating electricity.

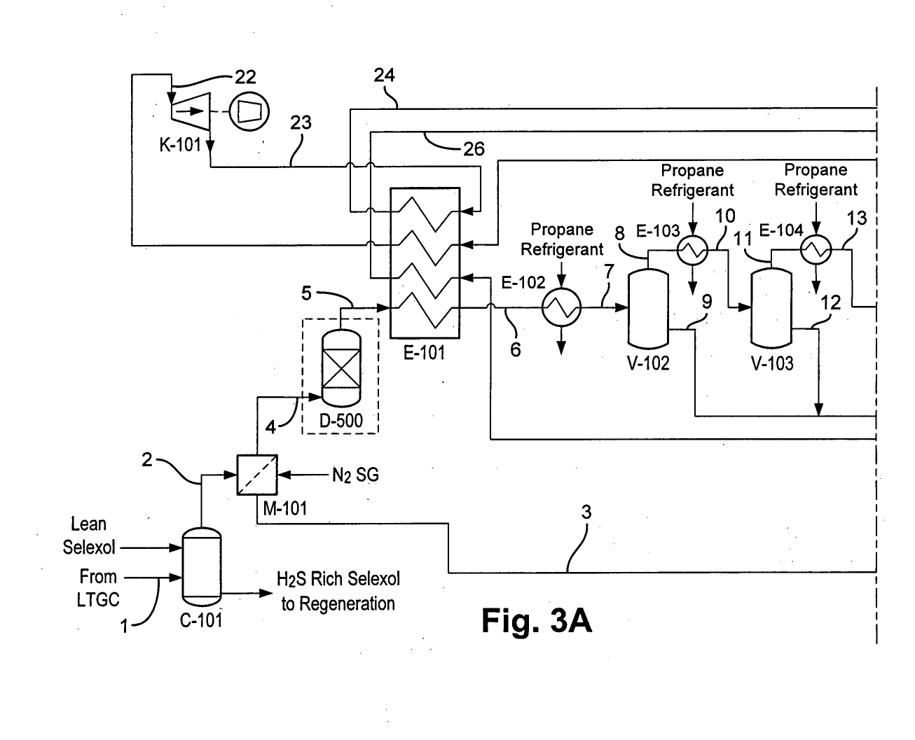

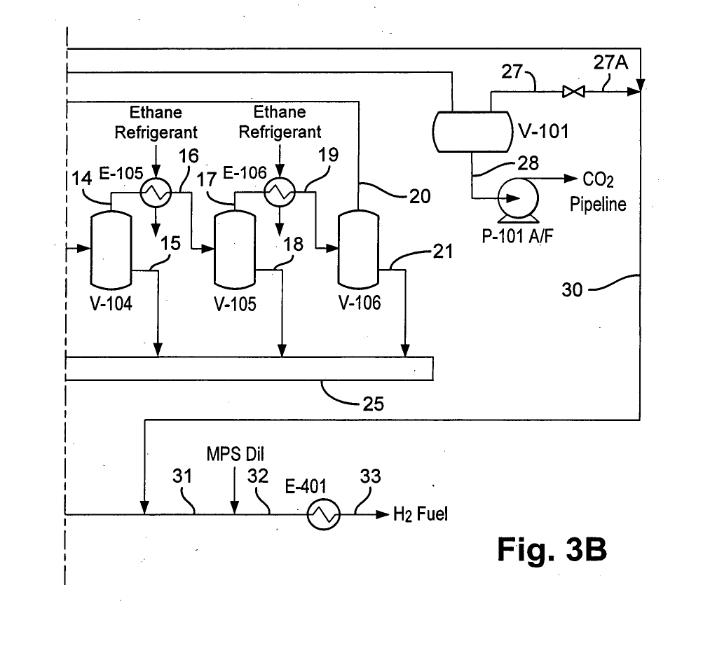

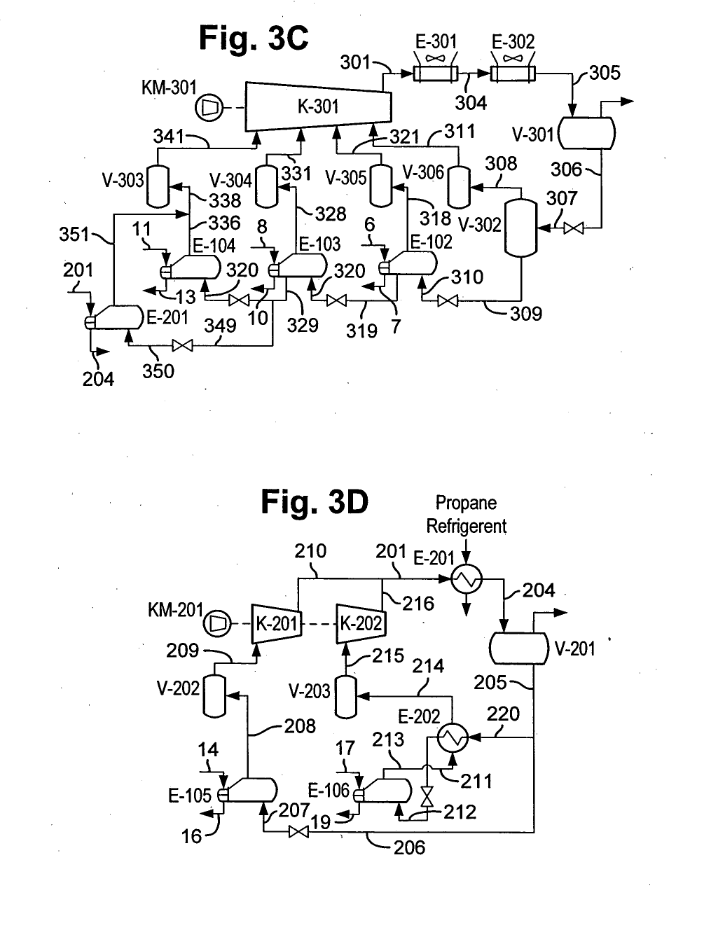

International Patent Application No. WO 2004/089499 relates to configurations and methods of acid gas removal from a feed gas, and especially removal of carbon dioxide and hydrogen sulfide from synthesis gas (syngas). In particular, WO 2004/089499 describes a plant that includes a membrane separator that receives a sulphur-depleted syngas and separates hydrogen from a carbon dioxide-containing reject gas. An autorefrigeration unit is preferably fluidly coupled to the membrane separator and receives the carbon dioxide-containing reject gas, wherein the autorefrigeration unit produces a carbon dioxide product and a hydrogen-containing offgas, and a combustion turbine receives the hydrogen and hydrogen-containing off-gas. In one especially preferred configuration, the shifted and desulfurised syngas is passed through a membrane separation unit to separate hydrogen from a carbon dioxide-rich reject gas, which is dried and liquefied using an autorefrigeration process. The hydrogen from the membrane separation unit is recompressed and then fed (optionally in combination with the autorefrigeration offgas) to the turbine combustor. In most preferred aspects, the turbine combustor is operationally coupled to a generator that produces electrical energy, and heat of the flue gas is extracted using a heat recovery steam generator (HRSG) that forms high pressure steam to drive a steam turbine generator. It is stated that the high operating pressure of the syngas that is fed to the membrane package is advantageously utilized to produce a permeate gas. The permeate gas that is rich in hydrogen has a pressure of about 100 psia. However, the pressure of the syngas feed to the membrane package is not given. The residual gas stream, enriched in CO₂, does not permeate the membrane. This residual gas stream is cooled in a heat exchanger (e.g. with an external refrigerant and an offgas vapour) and is separated into a liquid CO₂ portion and vapour portion. FIG. 3 indicates that the external refrigerant is propane and the offgas vapour is an internal refrigerant (cool hydrogen-containing offgas). The vapour portion is then further expanded in expander 360. The person skilled in the art would understand that expansion of the vapour stream results in cooling by the Joule-Thomson effect. The cooled expanded vapour portion is again separated to form a second liquefied CO₂ product which is combined to form a liquefied CO₂ stream and a hydrogen-containing offgas that is employed in the heat exchanger (see above) as internal refrigerant before being sent to the combustion turbine as fuel. It is said that the expansion energy recovered from the residual gas stream can be advantageously used in the recompression of the hydrogen-rich permeate in a compressor. The so compressed hydrogen-rich permeate may then be combined with the hydrogen-containing offgas and used as fuel in a combustion turbine. The autorefrigeration process of WO 2004/089499 provides two product streams from the syngas, a hydrogen rich offgas stream and a liquefied carbon dioxide stream, capturing about 70% of the total carbon dioxide in the shift effluent. This carbon dioxide can be pumped to approximately 2000 psia and used for Enhanced Oil Recovery (EOR). It should further be appreciated that at least part of the CO₂ can also be employed as a refrigerant (e.g. in a cold box or exchanger to reduce power consumption). The permeate gas from the membrane is re-compressed to approximately 350 psia and mixed with the hydrogen-rich stream from the autorefrigeration process. However, the power required to compress hydrogen is said to be considerable.

It has now been found that by feeding a shifted synthesis gas stream to a hydrogen selective membrane separation unit at a pressure of at least 50 bar gauge that the hydrogen rich permeate stream may be fed directly to the combustor of a gas turbine without any requirement to re-compress the hydrogen. It has also been found that the residual gas stream (carbon dioxide enriched stream) from the membrane separation unit may be cooled using at least one, preferably, at least two external refrigeration stages such that the hydrogen containing offgas is also obtained at above the operating pressure of the combustor of the gas turbine.

Thus, the present invention provides a process for (a) separating a synthesis gas stream into a hydrogen enriched vapour stream and a liquid carbon dioxide stream, (b) generating electricity from the separated hydrogen enriched stream by feeding the separated hydrogen enriched stream as a fuel gas stream to a combustor of at least one gas turbine of a power plant, and (c) sequestrating the liquid carbon dioxide stream, characterised in that said process comprises:
(A) (a) feeding a shifted synthesis gas stream at a pressure of at least 50 bar gauge to at least one membrane separator unit that is provided with membrane having a selectivity for H₂ over CO₂ of greater than 16; and (b) withdrawing from the membrane separation unit a hydrogen enriched permeate stream having a CO₂ content of 10 mole % or less and a carbon dioxide enriched retentate stream having a CO₂ content of at least 63 mole % CO₂, preferably, at least 70 mole % CO₂, wherein the hydrogen enriched permeate stream and the carbon dioxide enriched retentate stream are each withdrawn from the membrane separation unit at a pressure that is at or above the minimum fuel gas feed pressure for the combustor(s) of the gas turbine(s) of the power plant;
(B) (a) feeding the carbon dioxide enriched retentate stream to a carbon dioxide condensation plant that comprises a first cryogenic separation stage and optionally one or more further cryogenic separation stages arranged in series wherein the first cryogenic separation stage and optional further cryogenic separation stage(s) each comprise a heat exchanger and separator vessel; and (b) generating in the carbon dioxide condensation plant a further hydrogen enriched vapour stream having a CO₂ content of 10 mole % or less and at least one liquid stream comprising substantially pure liquid CO₂ by the steps of:
   (i) passing the carbon dioxide enriched retentate stream through the heat exchanger of the first cryogenic separation stage where the retentate stream is cooled against an external refrigerant to below its dew point thereby forming a cooled stream comprising a liquid phase and a vapour phase wherein the liquid phase comprises substantially pure liquid CO₂ and the vapour phase is enriched in hydrogen compared with the retentate stream;
   (ii) passing the two-phase stream from step (i) to the separator vessel of the first cryogenic separation stage where the liquid phase is separated from the vapour phase;
   (iii) withdrawing a liquid CO₂ stream and a hydrogen enriched vapour stream from the separator vessel of the first cryogenic separation stage;
   (iv) if the CO₂ content of the hydrogen enriched vapour stream is above 10 mole %, passing the hydrogen enriched vapour stream through the heat exchanger of a further cryogenic separation stage where the vapour stream is cooled against a further external refrigerant to below its dew point thereby forming a further cooled stream comprising a liquid phase and a vapour phase wherein the liquid phase comprises substantially pure liquid CO₂ and the vapour phase is further enriched in hydrogen compared with the retentate stream;
   (v) passing the two-phase stream from step (iv) to the separator vessel of the further cryogenic separation stage where the liquid phase is separated from the vapour phase;
   (vi) withdrawing a liquid CO₂ stream and a hydrogen enriched vapour stream from the separator vessel of the further cryogenic separation stage; and
   (vii) if necessary, repeating steps (iv) to (vi) by passing the hydrogen enriched vapour stream through one or more further cryogenic separation stages until the CO₂ content of the hydrogen enriched vapour stream that is withdrawn from the separator vessel of the further cryogenic separation stage is 10 mole % or less,
      wherein any pressure drop across the cryogenic separation stage(s) is controlled such that the further hydrogen enriched vapour stream having a hydrogen content of 10 mole % or less is obtained at a pressure that is at or above the minimum fuel gas feed pressure for the combustor(s) of the gas turbine(s) of the power plant;
(C) passing the hydrogen enriched vapour stream having a CO₂ content of less than 10 mole % that is formed in step (A) and/or the hydrogen enriched permeate stream having a CO₂ content of less than 10 mole % that is formed in step (B) as a fuel gas feed stream to the combustor(s) of the gas turbine(s) of the power plant for the production of electricity; and
(D) sequestering the liquid CO₂ stream(s) formed in step (B).

An advantage of the process of the present invention is that substantially all of the hydrogen is separated from the synthesis gas stream. A further advantage of the process of the present invention is that the separated hydrogen is obtained at a pressure that is at or above the minimum fuel gas feed pressure (inlet pressure) for the combustor(s) of the gas turbine(s) of the power plant. Typically, at least 99%, preferably, at least 99.5%, in particular, at least 99.8% of the hydrogen is separated from the shifted synthesis gas stream. A further advantage of the present invention is that at least 90% of the carbon dioxide is separated from the shifted synthesis gas stream.

A synthesis gas stream may be generated from a solid fuel such as petroleum coke or coal in a gasifier or from a gaseous hydrocarbon feedstock in a reformer. The synthesis gas stream from the gasifier or reformer contains high amounts of carbon monoxide. Accordingly, the synthesis gas stream is treated in a shift converter unit to generate a shifted synthesis gas stream. In the shift converter unit, substantially all of the carbon monoxide contained in the synthesis gas stream is converted to carbon dioxide over a shift catalyst according to the water gas shift reaction (WGSR)

CO+H₂O→CO₂+H_{2.}

The shift converter unit may be a single shift reactor containing a shift catalyst. However, it is preferred that the shift converter unit comprises a high temperature shift reactor containing a high temperature shift catalyst and a low temperature shift reactor containing a low temperature shift catalyst. The water gas shift reaction is exothermic and results in a significant temperature rise across the shift converter unit. Accordingly, the shift converter unit may be cooled by continuously removing a portion of the shifted synthesis gas stream and cooling this stream by heat exchange with one or more process streams, for example against boiler feed water or against steam (for the generation of superheated steam).

The shifted synthesis gas stream comprises primarily hydrogen, carbon dioxide and steam and minor amounts of carbon monoxide and methane. Where the shifted synthesis gas stream is derived from a gasifier, the shifted synthesis gas will also comprise minor amounts of hydrogen sulfide (H₂S) that is formed by reaction of COS with steam in the shift converter unit.

Typically, the shifted synthesis gas stream is passed to a plurality of membrane separation units that are arranged in parallel. The person skilled in the art will understand that the number of membrane separation units will be dependent upon the desired membrane area. Typically, the membrane separation unit(s) is provided with a spiral wound membrane or a tubular membrane platform, for example, a plurality of hollow fibre membranes. The membrane employed in the membrane separation unit(s) is selective for hydrogen over carbon dioxide such that hydrogen selectively passes through the membrane owing to its diffusivity (size) and/or solubility in the material that comprises the membrane. Typically, such membranes comprise a separation layer and a support layer. There are many types of membrane available that are selective for hydrogen over carbon dioxide including membranes comprising a polymeric selective layer, a microporous carbon selective layer, or a metal selective layer on a supporting material or substrate. Suitable polymeric materials for use as the selective layer include polybenzimidazole while suitable metals for use as the selective layer include palladium or palladium alloys. However, palladium or palladium alloy based membranes may only be employed where the shifted synthesis gas stream that is fed to the membrane separation unit(s) does not contain significant amounts of sulphur containing impurities, as these impurities will degrade the palladium or palladium alloy component of the membrane. Suitable supporting materials include porous ceramic materials, porous metals (for example, stainless steel) or porous polymeric materials.

Advantageously, the hydrogen selective membrane is a low temperature hydrogen selective membrane that is capable of operating at a temperature that is at or slightly above ambient temperature, for example at a temperature in the range of 0 to 50° C., in particular, 20 to 40° C. Suitable low temperature hydrogen selective membranes include polybenzimidazole (PBI)-based polymeric membranes comprising a PBI-based polymeric selective layer coated onto a porous metallic substrate (for example, a stainless steel substrate), a porous ceramic substrate or a porous polymer based substrate (for example, a PBI-based substrate). Although these membranes are capable of operating at low temperatures in the range of 0 to 50° C., the present invention does not preclude operating these membranes at higher temperatures.

It may be preferred to operate certain hydrogen selective membranes (for example, membranes comprising palladium or a palladium alloy on a supporting material) at higher temperatures as the H₂ permeability of these membranes has been found to increase significantly with temperature. Where the H₂ permeability of the membrane increases with increasing temperature, it may be desirable to operate the membrane separation unit(s) at a temperature of above 50° C., for example, at a temperature in the range of 75 to 400° C., preferably, 100 to 300° C.

The presence of steam in the hot shifted synthesis gas lowers the partial pressure of hydrogen in the shifted synthesis gas stream that is fed to the membrane separation unit(s). Accordingly, the shifted synthesis gas stream may be cooled upstream of the membrane separation unit(s), for example, to a temperature in the range of 20 to 50° C., for example, about 40° C. to condense out a condensate (predominantly comprised of water). The condensate is then separated from the cooled shifted synthesis gas stream, for example, in a condensate drum. If necessary, the cooled shifted synthesis gas stream is subsequently reheated to the desired membrane operating temperature, for example, to a temperature in the range of 75 to 400° C., prior to being fed to the membrane separation unit(s). Typically, the cooled shifted synthesis gas stream may be reheated to the membrane operating temperature against a hot process stream or steam.

It is also envisaged that the hot shifted synthesis gas stream from the shift converter unit may be passed to the membrane separation unit(s) without cooling to condense out a condensate. Accordingly, the water that is contained in the hot shifted synthesis gas is in a vapour state (steam). Typically, at least a portion of the steam that is contained in the hot shifted synthesis gas will pass through the membrane together with the hydrogen. The presence of steam in the H₂ enriched permeate stream may be advantageous as this may reduce NOₓ emissions from the combustor of the gas turbine(s). Typically, a diluent, for example, nitrogen, is added to the fuel feed stream that is fed to the combustor of the gas turbine(s). Thus, a further advantage of the presence of steam in the H₂ enriched permeate stream is that this reduces the required dilution. Accordingly, there may be no requirement to remove the steam from the permeate stream. The CO₂ enriched retentate stream that is removed from the membrane separation unit(s) is at elevated temperature and is cooled downstream of the membrane separation unit(s), for example, against water, before entering the CO₂ condensation plant. Where significant amounts of steam are retained in the CO₂ enriched retentate stream, a condensate (predominantly water) will condense out of the retentate stream and is removed, for example, in a condensate drum.

The shifted synthesis gas stream is fed to the membrane separation unit(s) at a pressure of at least 50 barg, preferably, at a pressure of at least 60 barg. Typically, the shifted synthesis gas stream is fed to the membrane separation unit(s) at a pressure in the range of 50 to 65 barg, for example, 50 to 60 barg. If necessary, the pressure of the shifted synthesis gas stream is boosted to the desired operating pressure of the membrane separation unit(s). Thus, a compressor may be installed upstream of the membrane separation unit(s).

Typically, the CO₂ enriched retentate stream may be withdrawn from the membrane separation unit(s) at a pressure that is 2 to 3 bar below the pressure of the shifted synthesis gas feed stream. However, the person skilled in the art will understand that there is a pressure drop across the membrane of the membrane separation unit(s) so that the hydrogen enriched permeate stream is withdrawn from the membrane separation unit(s) at a pressure significantly below the pressure of the shifted synthesis gas feed stream. Preferably, the pressure drop across the membrane is less than 20 bar, more preferably, less than 15 bar, in particular, less than 10 bar so that the hydrogen enriched permeate stream is obtained at a pressure greater than the minimum feed gas pressure (minimum inlet pressure) for the combustor(s) of the gas turbine(s) of the power plant. Accordingly, there is no requirement to compress the hydrogen enriched permeate stream that is passed as the fuel gas feed stream to the combustor(s) of the gas turbine(s) of the power plant. It is preferred to feed a sweep gas (for example, nitrogen and/or steam) to the permeate side of the membrane of the membrane separation unit(s) to mitigate the risk of the pressure of the hydrogen enriched permeate stream falling to below the minimum feed gas pressure for the combustor of the gas turbine(s) of the power plant. Typically, the sweep gas is fed to the permeate side of the membrane of the membrane separation unit(s) in an amount such that the pressure drop across the membrane is minimized. For example, the sweep gas may be fed to the permeate side of the membrane of the membrane separation unit(s) in an amount such that the pressure drop across the membrane is less than 10 bar, preferably, less than 5 bar. A further advantage of employing a sweep gas is that this improves the performance of the hydrogen selective membrane. Thus, the addition of the sweep gas reduces the hydrogen partial pressure of the permeate stream and therefore improves the separation efficiency. In addition, where nitrogen is employed as the sweep gas, this will dilute the hydrogen content of the fuel stream to the level required for combustion in the combustor of the gas turbine(s). Typically, the hydrogen enriched permeate stream is diluted with nitrogen sweep gas to a hydrogen content of 40 to 70 mole %, preferably 40 to 60 mole %. For avoidance of doubt, where a sweep gas is fed to the permeate side of the membrane, the CO₂ content of the hydrogen enriched permeate stream is based on the gaseous composition excluding the sweep gas.

The hydrogen selective membrane that is employed in the membrane separation unit(s) has a H₂ selectivity (over CO₂) of greater than 16, in order to prevent significant quantities of CO₂ from entering the hydrogen enriched permeate stream as this would reduce the CO₂ capture level. Preferably the hydrogen selectivity of the membrane is greater than 20, in particular greater than 40. Typically, the CO₂ content of the hydrogen enriched permeate stream is less than 10 mole %, preferably, less than 5 mole %, in particular, less than 2 mole %. Typically, the CO₂ content of the CO₂ enriched retentate stream is in the range of 63 to 85 mole %, preferably 70 to 85 mole %.

A discussed above, where the shifted synthesis gas stream is derived from a synthesis gas stream that is formed by gasification of petroleum coke or coal in a gasifier, the shifted synthesis gas will contain H₂S as an impurity (sour shifted synthesis gas). An advantage of the process of the present invention is that it allows the capture of the H₂S in addition to carbon dioxide (CO₂). Any H₂S that is captured may be either converted into elemental sulphur using the Claus Process or into industrial strength sulphuric acid. Typically, the H₂S may be captured either upstream or downstream of the membrane separation unit. For example, the H₂S may be selectively absorbed from the sour shifted synthesis gas stream in an absorption tower arranged upstream of the membrane separation unit(s). Alternatively, H₂S may be selectively absorbed from the CO₂ enriched retentate stream in an absorption tower arranged downstream of the membrane separation unit. Typically, Selexol™ (a mixture of dimethyl ethers of polyethylene glycol) may be employed as the absorbent. Where the feed to the membrane separation unit(s) is a sour shifted synthesis gas, it is envisaged that a portion of the H₂S may pass through the hydrogen selective membrane such that the hydrogen enriched permeate stream contains H₂S as an impurity. Accordingly, the hydrogen enriched permeate stream is passed through a bed of a solid absorbent that is capable of absorbing H₂S, for example, a bed of zinc oxide, thereby desulfurising the hydrogen enriched permeate stream.

After removal of any condensate (see above), the CO₂ enriched retentate stream is dried prior to being passed to the CO₂ condensation plant, as any moisture in the CO₂ enriched retentate stream will freeze and potentially cause blockages in the plant. The CO₂ enriched retentate stream may be dried by being passed through a molecular sieve bed or an absorption tower that employs triethylene glycol to selectively absorb the water. Preferably, the dried CO₂ enriched retentate stream has a water content of less than 1 ppm (on a molar basis).

Preferably, the dried CO₂ enriched retentate stream is then passed to a pre-cooling heat exchanger of the CO₂ condensation plant where the retentate stream is pre-cooled against a cold stream (for example, cold water or a cold process stream such as a liquid CO₂ product stream or a cold H₂ enriched vapour stream). Typically, the retentate stream is pre-cooled to a temperature in the range 0 to 10° C., for example, about 2° C. Depending upon the composition of the CO₂ enriched retentate stream, the pre-cooled stream may remain in a vapour state or may be cooled to below its dew point thereby becoming two phase.

The retentate stream is then passed through at least one cryogenic separation stage of the CO₂ condensation plant, preferably, through a plurality of cryogenic separation stages that are arranged in series. Each cryogenic separation stage comprises a heat exchanger that employs an external refrigerant and a gas-liquid separation vessel. Preferably, the CO₂ condensation plant comprises 2 to 10, more preferably, 4 to 8, for example, 5 to 7 cryogenic separation stages arranged in series.

By “external refrigerant” is meant a refrigerant that is formed in an external refrigeration circuit. Accordingly, liquid CO₂ that is formed in the process of the present invention is not regarded as an external refrigerant. Suitable external refrigerants that may be used as refrigerant in the heat exchanger(s) of the separation stages(s) include propane, ethane, ethylene, ammonia, hydrochlorofluorocarbons (HCFC's) and mixed refrigerants. Typical mixed refrigerants comprise at least two refrigerants selected from the group consisting of butanes, propanes, ethane, and ethylene. These refrigerants may be cooled to the desired refrigeration temperature in external refrigerant circuits using any method known to the person skilled in the art including methods known in the production of liquefied natural gas.

Where the CO₂ condensation plant comprises a plurality of cryogenic separation stages arranged in series, the separator vessels of the cryogenic separation stages are operated at successively lower temperatures. The operating temperature of each cryogenic separation stage will depend on the number of cryogenic separation stages and the desired carbon dioxide capture level. There is a limit on the lowest temperature in the final cryogenic separation stage, as the temperature must be maintained above a value where solid CO₂ will form. This typically occurs at a temperature of less than −50° C. at pressures of less than 300 barg (the triple point for pure CO₂ is at 5.18 bar and at a temperature of −56.4° C.) although the presence of H₂ may depress this freezing point.

There is minimal pressure drop across the cryogenic separation stage(s) of the CO₂ condensation plant. Typically, the pressure drop across the cryogenic separation stage(s) of the CO₂ condensation plant is in the range of 2 to 10 bar, preferably, 2 to 5 bar, in particular, 2 to 3 bar. Thus, a multistage CO2 condensation plant may be operated with the cryogenic separation stages at substantially the same pressure. Higher pressure drops across the cryogenic separation stage(s) may be tolerated (for example, pressure drops in the range of 10 to 30 bar, preferably 10 to 20 bar) provided that the pressure of the H₂ enriched vapour stream that is removed from the separator vessel of a single stage CO₂ condensation plant or from the separator vessel of the final cryogenic separation stage of a multistage carbon dioxide condensation plant is at or above the minimum feed gas pressure (minimum inlet pressure) for the combustor(s) of the gas turbine(s) of the power plant.

The process of the present invention will now be described with respect to a CO₂ condensation plant that comprises a plurality of cryogenic separation stages. The retentate stream is passed through the heat exchanger of the first cryogenic separation stage where the retentate stream is cooled to below its dew point against an external refrigerant thereby forming a two phase stream comprising a liquid phase (substantially pure liquid CO₂) and a vapour phase (comprising H₂ and residual CO₂). The two phase stream is then passed to the gas-liquid separator vessel of the first cryogenic separation stage where the liquid phase is separated from the vapour phase. A hydrogen enriched vapour stream and a liquid CO₂ stream are withdrawn from the separator vessel, preferably, from at or near the top and bottom respectively of the separator vessel. The H₂ enriched vapour stream is then used as feed to a further cryogenic separation stage where the vapour stream is passed through a further heat exchanger and is cooled to below its dew point against a further external refrigerant. The resulting two phase stream is passed to the gas-liquid separator vessel of the further cryogenic separation for separation of the phases. A vapour stream that is further enriched in H₂ and a liquid CO₂ stream are withdrawn from the separator vessel, preferably, from at or near the top and bottom respectively of the separator vessel. These steps may be repeated until sufficient CO₂ has been captured from the H₂ enriched vapour stream (non-condensable stream) that is withdrawn from the final cryogenic separation stage of the series. Thus, the feed to the second and any subsequent cryogenic separation stage is the H₂ enriched vapour stream (non-condensable stream) that is separated in the preceding cryogenic separation stage in the series. Typically, the amount of CO₂ contained in the H₂ enriched vapour stream (non-condensable stream) that is removed from the final cryogenic separation stage of the CO₂ condensation plant is less than 10 mole %, preferably, less than 5 mole %, in particular, less than 2 mole %.

The person skilled in the art will understand that the H₂ enriched vapour stream that is fed to the second cryogenic separation stage of the CO₂ condensation plant is of higher H₂ content than the CO₂ enriched retentate stream that is fed to the first cryogenic separation stage of the CO₂ condensation plant. Also, the H₂ enriched vapour stream that is fed to any third or further cryogenic separation stage(s) of the CO₂ condensation plant is of successively higher H₂ content. Where the H₂ enriched vapour stream that is withdrawn from the separator vessel of an intermediate cryogenic separation stage is sufficiently enriched in hydrogen (has a H₂ content of at least 40 mole %, preferably, at least 50 mole %), this H₂ enriched vapour stream may be passed to a further membrane separation unit of the CO₂ condensation plant where a hydrogen selective membrane is used to separate a hydrogen enriched permeate stream from a CO₂ enriched retentate stream. The hydrogen enriched permeate stream has a CO₂ content of less than 10 mole %, preferably, less than 5 mole %, in particular, less than 2 mole %. If desired, a sweep gas may be fed to the permeate side of the membrane of the further membrane separation unit(s) of the CO₂ condensation plant, as described above. Where a sweep gas is fed to the permeate side of the membrane, the CO₂ content of the hydrogen enriched permeate stream is based on the gaseous composition excluding the sweep gas.

This hydrogen enriched permeate stream is obtained at a similar pressure to the hydrogen enriched permeate stream that is arranged upstream of the CO₂ condensation plant so that the two hydrogen enriched permeate streams may be combined. Preferably, the two H₂ enriched permeate streams are combined upstream of any H₂S absorbent bed. The CO₂ enriched permeate stream is then used as feed to a further cryogenic separation stage of the CO₂ condensation plant. The use of a membrane separator unit within the CO₂ condensation plant may allow the elimination of one or more cryogenic separation stages or allow the subequent cryogenic separation stage(s) to be operated at a higher temperature thereby reducing the refrigeration duty. It is envisaged that the CO₂ condensation plant may comprise more than one membrane separation unit. For example, the CO₂ condensation plant may comprise at least one cryogenic separation stage upstream of a first membrane separation unit, at least one cryogenic separation stage downstream of the first membrane unit and upstream of a second membrane separation unit and at least one cryogenic separation stage downstream of the second membrane unit. If necessary, the H₂ enriched vapour feed to the membrane separation unit(s) of the CO₂ condensation plant is heated (against a hot process stream or steam) to above the operating temperature of the hydrogen selective membrane. It may therefore be necessary to subsequently cool the CO₂ enriched retentate stream that is formed in the membrane separation unit (against a cold process stream or water) before passing the CO₂ enriched retentate stream to a subsequent cryogenic separation stage.

Typically, the hydrogen enriched vapour stream (non-condensable stream) from the final cryogenic separation stage of the CO₂ condensation plant comprises at least 90 mole % hydrogen, preferably, at least 95% hydrogen, more preferably, at least 98 mole % hydrogen, in particular, at least 99 mole % hydrogen, the remainder being mostly carbon dioxide. Typically, the amount of CO₂ contained in the H₂ enriched vapour stream that is removed from the fmal cryogenic separation stage of the CO₂ condensation plant is less than 10 mole % CO₂, preferably, less than 5 mole % CO₂, more preferably, less than 2 mole % CO₂, in particular, less than 1 mole % CO₂ (depending upon the desired carbon dioxide capture level). This hydrogen enriched stream may also comprise trace amounts of carbon monoxide (CO) and methane, for example, less than 500 ppm on a molar basis. The H₂ enriched vapour stream from the final cryogenic separation stage of the CO₂ condensation plant is obtained at a pressure that is at or above the minimum fuel gas feed pressure for the combustor(s) of the gas turbine(s). Accordingly, this H₂ enriched vapour stream may be combined with the H₂ enriched permeate stream from the membrane separator unit(s) to form a fuel stream that is fed to the combustor of at least one gas turbine that drives an electric generator thereby producing electricity.

Although the process of the present invention has been described with respect to a CO₂ condensation plant comprising two or more cryogenic separation stages arranged in series, it is also envisaged that there may be a single cryogenic separation stage. Where the CO₂ condensation plant comprises a single separation stage, ethane and/or ethylene is used as external refrigerant in order to achieve a sufficiently low temperature in the separation vessel (of approximately −50° C.) to condense out sufficient CO₂ to achieve the desired carbon dioxide capture level of less than 10 mole %, preferably, less than 5 mole %, in particular, less than 2 mole % in the H₂ enriched vapour stream.

As discussed above, the hydrogen enriched permeate stream from the membrane separation unit(s) is obtained at a pressure at or above the minimum feed gas pressure (minimum inlet pressure) for the combustor(s) of the gas turbine(s) of the power plant. Typically, the fuel gas feed pressure (inlet pressure) for the combustor of the gas turbine(s) is in the range of 25 to 45 barg, preferably, 28 to 40 barg, in particular, 30 to 35 barg. Typically, the combustor of the gas turbine(s) is operated at a pressure of 15 to 20 bar absolute.

The hydrogen enriched vapour stream (non-condensable stream) from the CO₂ condensation plant is also obtained at a pressure that is at or above the minimum fuel gas feed pressure for the combustor(s) of the gas turbine(s). Accordingly, an advantage of the present invention is that there is no requirement for a gas compressor to compress the hydrogen fuel gas stream to the inlet pressure for the combustor(s) of the gas turbine(s). Typically, the H₂ enriched vapour stream (non-condensable stream) from the CO₂ condensation plant is obtained at a pressure that is substantially above, for example, 10 to 20 bar above the inlet pressure of the combustor(s) of the gas turbine(s) of the power plant. Accordingly, the H₂ enriched vapour stream may be expanded in an expander, for example, a turboexpander, down to the inlet pressure of the combustor(s) of the gas turbine(s). The expansion energy recovered from the H₂ enriched vapour stream in the expander can be converted into power for export or for use within the process (e.g. to drive the CO₂ pumps).

Preferably, the hydrogen fuel stream that is fed to the combustor of the gas turbine(s) contains 35 to 65 mole % hydrogen, more preferably, 45 to 60 mole % hydrogen, for example, 48 to 52 mole % of hydrogen. It is envisaged that the hydrogen stream may comprise trace amounts of carbon oxides (CO and CO₂) and of methane. The remainder of the hydrogen fuel stream is nitrogen and/or steam arising from the sweep gas and/or added as a diluent to the hydrogen fuel stream.

The exhaust gas from the gas turbine(s) is passed to a heat recovery and steam generator unit (HRSG) where the exhaust gas may be heat exchanged with various process streams. Optionally, the temperature of the exhaust gas from the gas turbine is increased by providing the HRSG with a post-firing system, for example, a post-firing burner. Suitably, the post-firing burner is fed with a portion of the hydrogen fuel stream and the hydrogen fuel stream is combusted in the burner using residual oxygen contained in the exhaust gas. Suitably, the exhaust gas is raised in temperature in the post-firing system to a temperature in the range of 500 to 800° C.

Typically, the HRSG generates and superheats steam for use in at least one steam turbine and elsewhere in the process of the present invention. Typically, the HRSG is capable of generating high pressure (HP) steam, medium pressure (MP) steam and low pressure (LP) steam and of superheating these steam streams. The HRSG may also be capable of reheating MP steam that is produced as an exhaust stream from the high pressure stage of a multistage steam turbine. In addition, the HRSG may be used to heat boiler feed water (for example, boiler feed water that is fed to the waste heat boiler of a shift converter unit).

The cooled exhaust gas is discharged from the HRSG to the atmosphere through a stack. Preferably, the stack is provided with a continuous emission monitoring system for monitoring, for example, the NOₓ content of the cooled exhaust gas.

The liquid CO₂ streams that are withdrawn from the separator vessel(s) of the cryogenic separation stage(s) preferably comprise at least 95 mole % CO₂, in particular, at least 98 mole % CO₂, the remainder being mostly hydrogen with some inerts, for example, nitrogen and/or CO. Preferably, these liquid CO₂ streams are combined and the resulting combined stream is then pumped to the desired export pressure, for example, the pipeline delivery pressure. The combined stream may then be transferred by pipeline to a reception facility of an oil field where the combined stream may be used as an injection fluid in the oil field. If necessary, the combined stream is further pumped to above the pressure of an oil reservoir before being injected down an injection well into the oil reservoir. The injected CO₂ displaces the hydrocarbons contained in the reservoir rock towards a production well for enhanced recovery of hydrocarbons therefrom. If any carbon dioxide is produced from the production well together with the hydrocarbons, the carbon dioxide may be separated from the hydrocarbons for re-injection into the oil reservoir such that the CO₂ is sequestered in the oil reservoir. It is also envisaged that the combined stream may be injected into an aquifer or a depleted oil or gas reservoir for storage therein.

The process of the present invention will now be illustrated by reference to the following Figures.

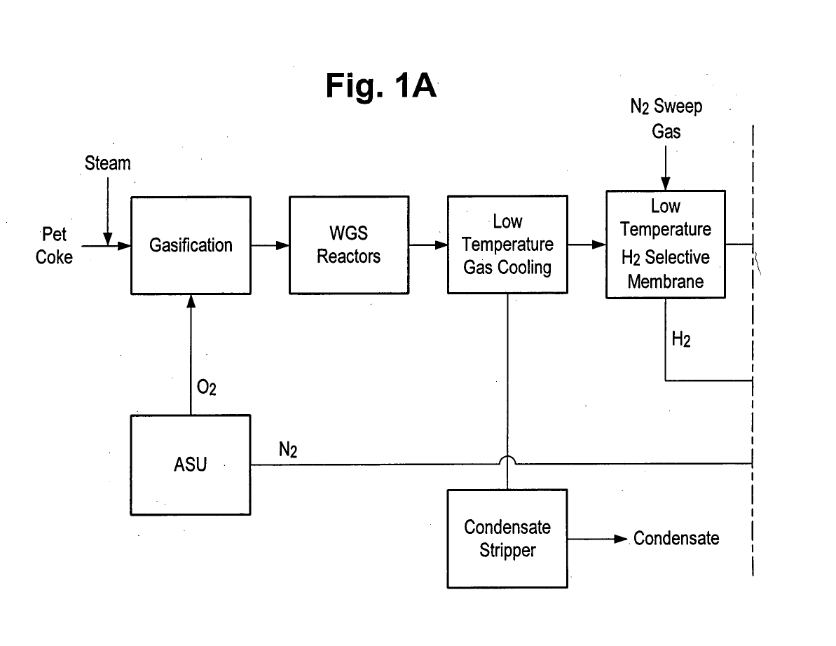

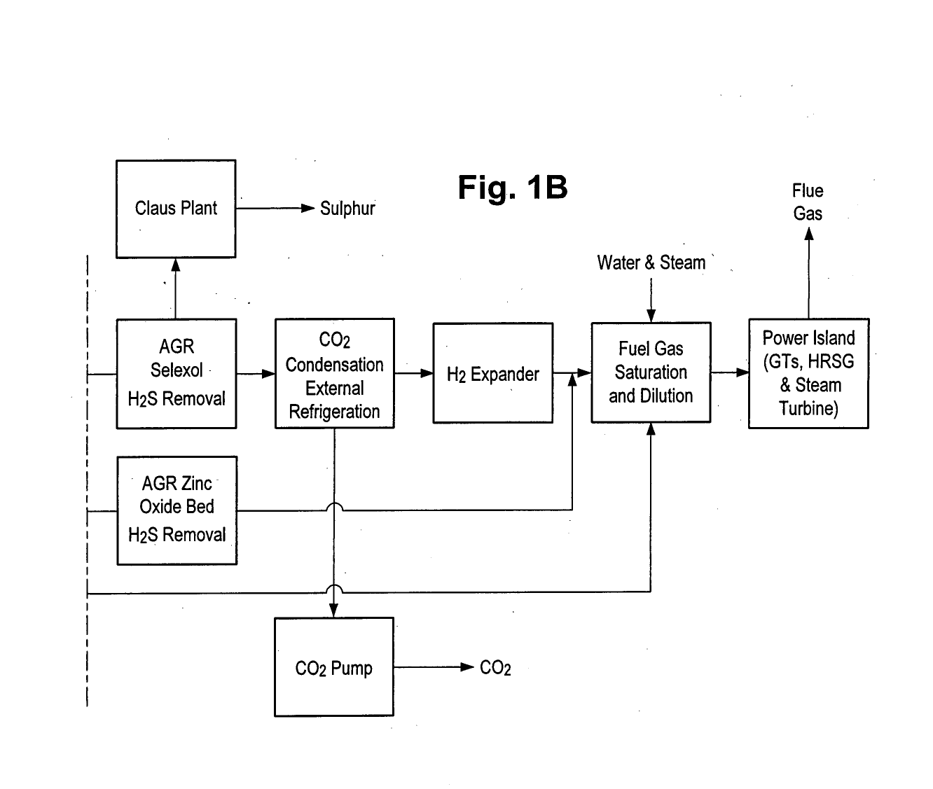

FIGS. 1A/1B show a block flow diagram that illustrates the production of a synthesis gas stream comprising hydrogen and carbon dioxide and the separation of a hydrogen enriched fuel stream from a carbon dioxide stream using a hydrogen selective membrane separation unit upstream of a CO₂ condensation plant.

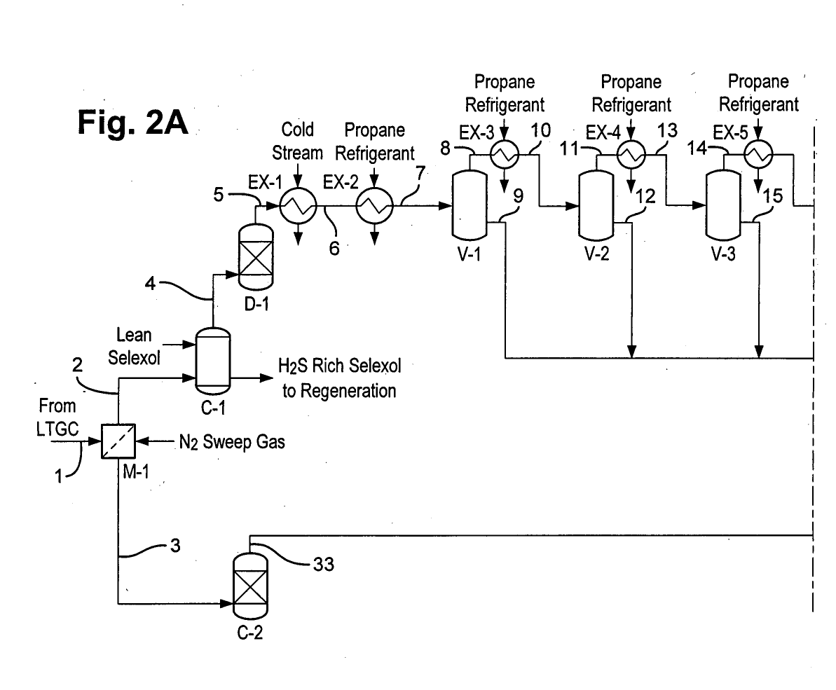

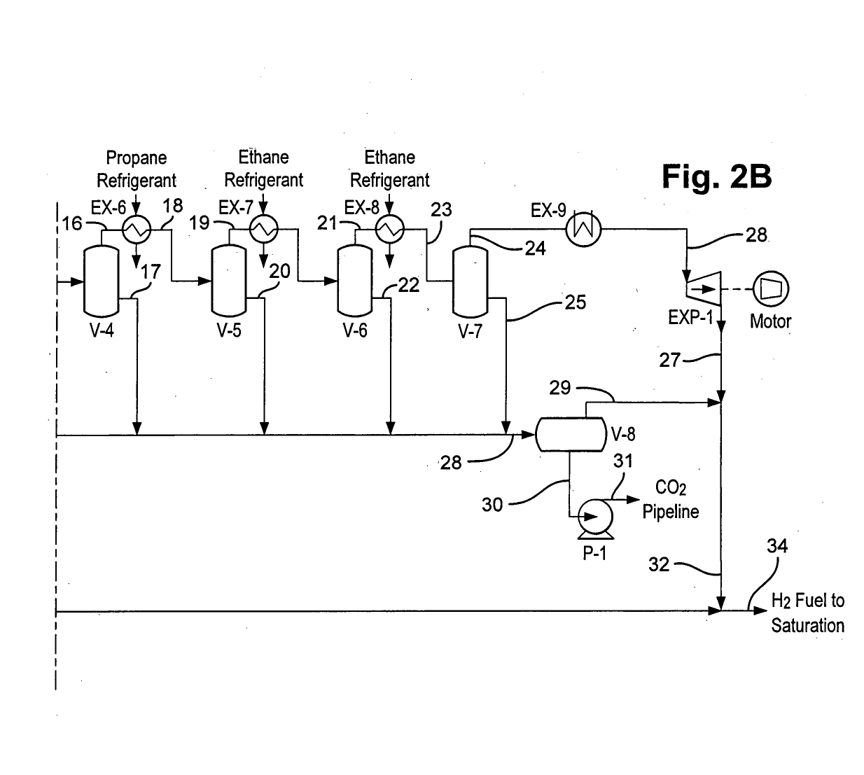

FIGS. 2A/2B and FIGS. 3A/3B/3C/3D provide a more detailed view of the membrane separation unit and the CO₂ condensation plant for the capture of CO₂ from a synthesis gas stream.

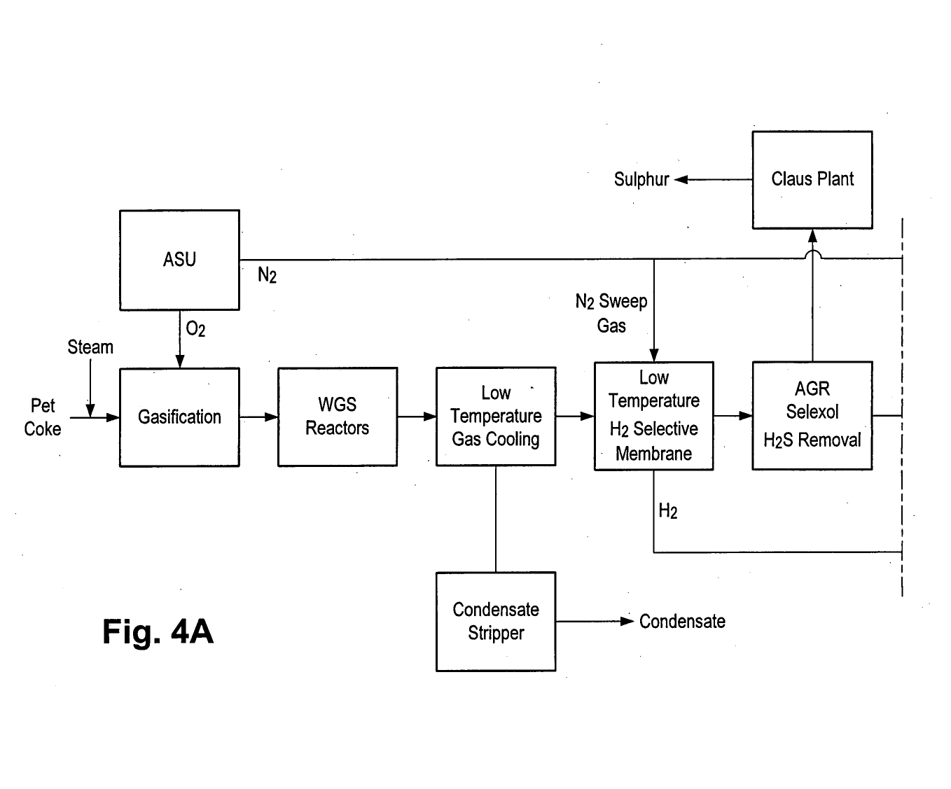

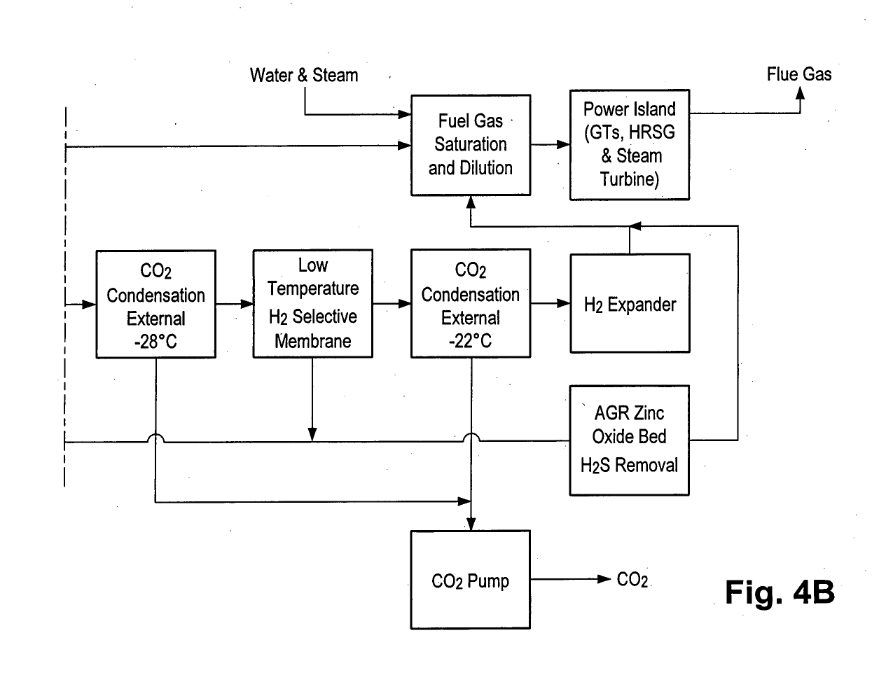

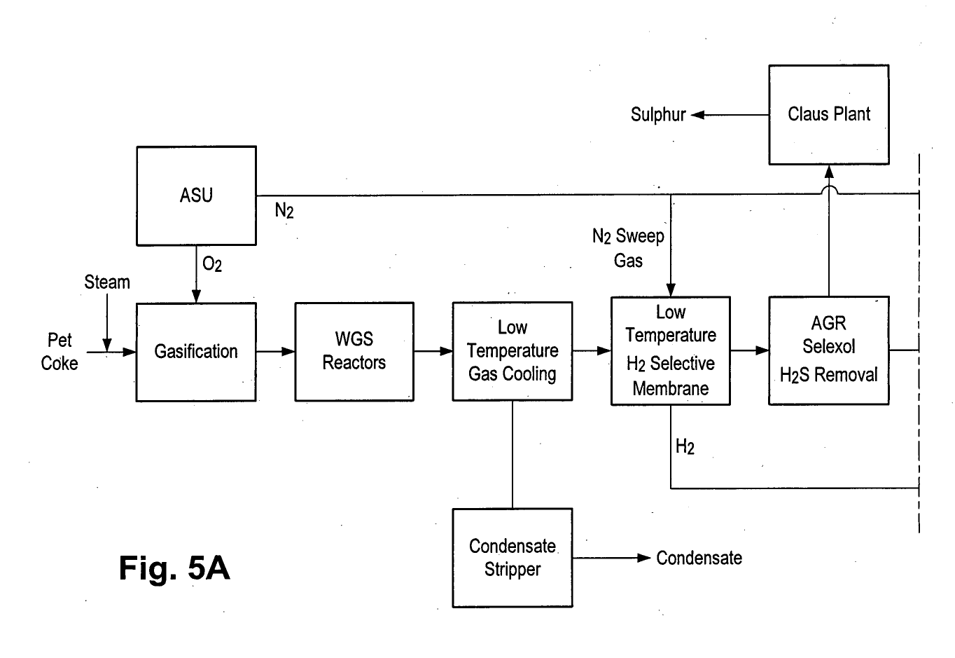

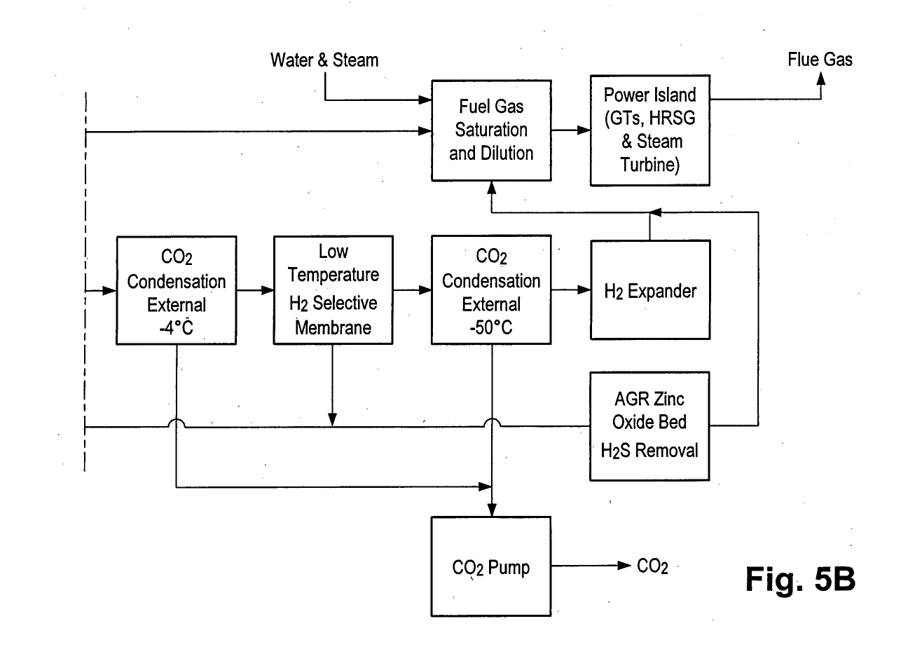

FIGS. 4A/4B and FIGS. 5A/5B are block flow diagrams that illustrate modified schemes for separating a hydrogen enriched fuel stream from a carbon dioxide enriched stream in which there is a second hydrogen selective membrane separation unit within the CO₂ condensation plant.

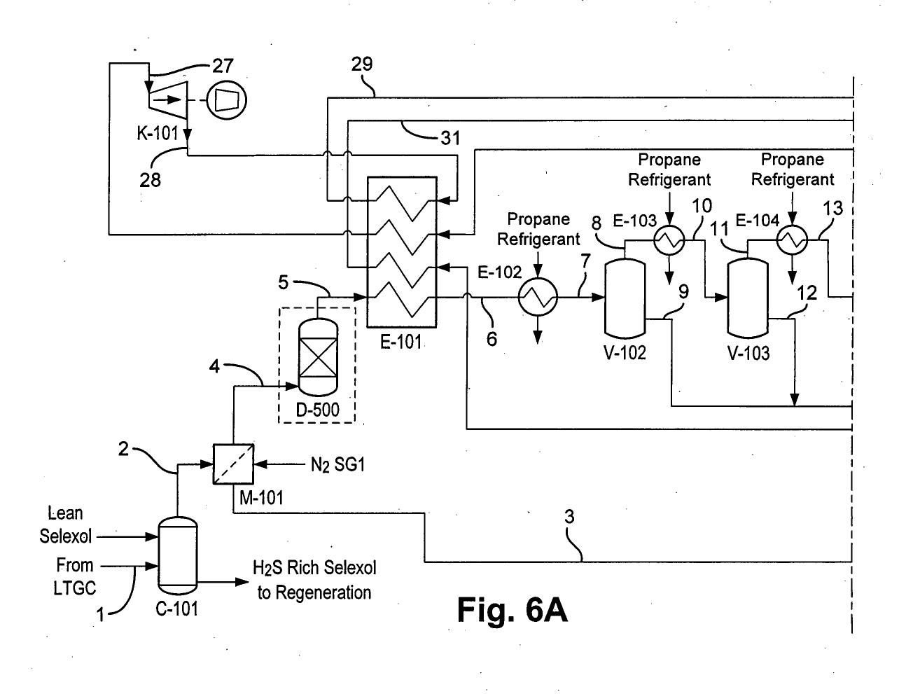

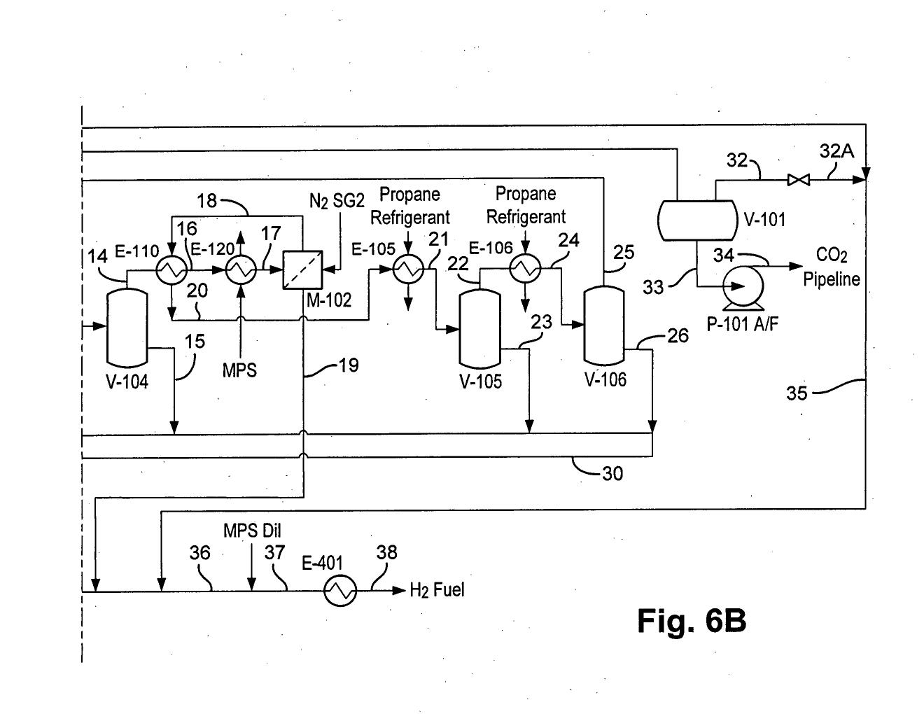

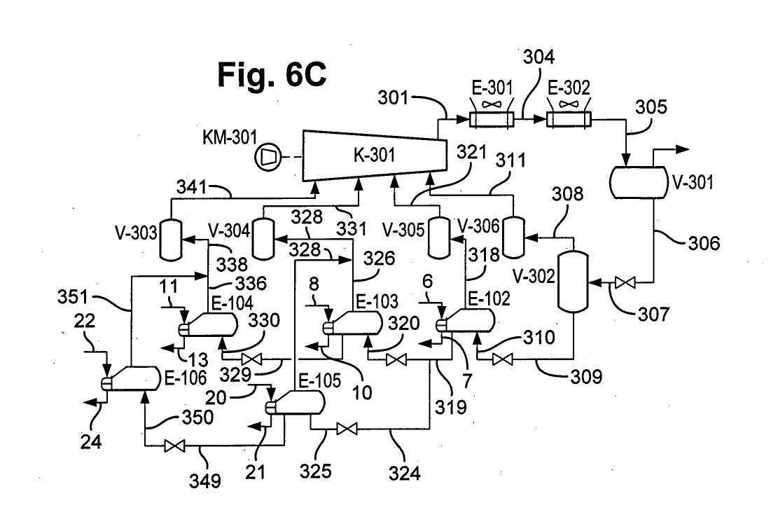

FIGS. 6A/6B/6C provides a more detailed view of a modified scheme that employs a second hydrogen selective membrane.

In FIGS. 1A/1B, a fuel, either petroleum coke or coal, is pre-processed (crushed and slurried with water) prior to being sent to a gasifier. Steam is added to the petroleum coke or coal upstream of the gasifier. In addition, oxygen is fed into the gasifier from an Air Supply Unit (ASU) in order to provide heat to the gasification process and to partially oxidise the fuel. The ASU also provides a source of nitrogen which is used as a diluent for the hydrogen fuel stream that is fed to the gas turbines (GTs) of a Power Island. The gasifier converts the petroleum coke or coal fuel to a synthesis gas stream (commonly known as syngas), which is a mixture of predominantly hydrogen (H₂), carbon monoxide (CO), carbon dioxide (CO₂), hydrogen sulfide (H₂S), COS, water (steam) and other minor impurities (inerts and heavy metals).

In order to convert the syngas to a mixture of predominantly CO₂ and hydrogen, the syngas is passed to Water Gas Shift (WGS) reactors. Depending on the amount of H₂S in the petroleum coke or coal fuel, these WGS reactors may be sour WGS reactors, and will convert CO to CO₂ and COS to H₂S. Typically, the number of WGS reactors will be dependent on the amount of CO generated from the gasifier and the level of CO₂ capture the plant is aiming to achieve. Typically, two stages of WGS are used.

The sour shifted syngas from the WGS Reactors is then subjected to Low Temperature Gas Cooling to knock out water contained in the sour shifted syngas. Typically, this is achieved by cooling the sour shifted syngas to a temperature of approximately 30 to 40° C. in a heat exchanger against boiler feed water thereby generating steam. Cooling results in condensation of the majority of the water which is separated in a knockout drum. In practise, cooling of the sour shifted syngas generates two steam streams, low pressure (LP) steam and medium pressure (MP) steam. These steam streams may be used in the upstream plant (gasifier) or sent to a steam turbine for electricity generation. The water that is separated in the knock-out drum will contain trace amounts of CO₂ and other impurities. These impurities are stripped from the condensate in a Condensate Stripper. The remaining condensate (water) is then used as boiler feed water.

The shifted syngas from the Low Temperature Gas Cooling Stage is then sent, at a pressure of at least 50 barg to a Low Temperature (LT) Hydrogen Selective Membrane separation unit. The membrane employed in the membrane separation unit is selective for hydrogen over carbon dioxide (selectivity of greater than 16).

In order to improve the performance of the membrane a nitrogen and/or steam sweep gas may be added to the permeate stream. The addition of the nitrogen and/or steam sweep gas reduces the hydrogen partial pressure and improves the separation efficiency. The addition of the sweep gas also minimizes the pressure drop across the membrane and hence mitigates the risk of the pressure of the permeate stream falling to below the minimum feed gas pressure for the hydrogen fuel stream that is fed to the combustors of the gas turbines (GTs) of a Power Island (thereby avoiding the need for a hydrogen compressor). In addition, where nitrogen is employed as the sweep gas, this will dilute the hydrogen permeate stream to the level required for combustion in the gas turbine (GT) of the Power Island. Where the hydrogen permeate stream contains low amounts of H₂S impurity, the hydrogen permeate stream is passed through a H₂S absorbent, for example, a zinc oxide bed, prior to combustion of the hydrogen fuel stream in the GT.

The CO₂ enriched retentate stream from the membrane separation unit comprises at least 70 mole % CO₂ (typically, 70 to 80 mole % CO₂) and is sent to an Acid Gas Removal (AGR) plant where the H₂S is stripped out of the CO₂ enriched stream via the use of a physical or chemical absorbent in an absorption tower. Typically Selexol™ (a mixture of dimethyl ethers of polyethylene glycol) is used as absorbent. The separated H₂S may be passed to a Claus plant for the production of elemental sulphur, or may be converted to sulphuric acid in a sulphuric acid plant.

The CO₂ enriched retentate stream is then dried, as any moisture in the retentate stream will cause freezing and blockages in downstream processing equipment. Viable options for dehydrating the CO₂ enriched retentate stream include passing the gas through a molecular sieve bed or through an absorption tower that uses triethylene glycol (TEG) as absorbent. Typically, the water content of the dried CO₂ enriched retentate stream is less than 1 ppm (molar basis).

Once dehydrated, the CO₂ enriched retentate stream is sent to a CO₂ condensation plant comprising one or more cryogenic separation stages that will liquefy at least a portion the CO₂ and separate a liquid CO₂ stream from a vapour stream that is enriched in H₂. Thus, the retentate stream is cooled to below its dewpoint against an external refrigerant in a heat exchanger of a first cryogenic separation stage of the CO₂ condensation plant so that the stream becomes two phase (a liquid phase comprising substantially pure liquid CO₂ and a vapour phase comprising CO₂ and H₂ that is enriched in H₂ compared with the retentate stream). The liquid phase is then separated from the vapour phase in a separator vessel of the first cryogenic separation stage with a liquid CO₂ stream and a hydrogen enriched vapour stream being removed from at or near the bottom and top of the separator vessel respectively. Where the CO₂ content of the hydrogen enriched vapour stream is above 10 mole %, the level of CO₂ capture is unacceptable. Accordingly, the hydrogen enriched vapour stream is cooled to below its dewpoint against a further external refrigerant in a heat exchanger of a further cryogenic separation stage of the CO₂ condensation plant so that the stream becomes two phase and a liquid phase (substantially pure liquid CO₂) is then separated from a vapour phase (that is further enriched in hydrogen) in a separator vessel of the further cryogenic separation stage. This may be repeated using further cryogenic separation stages until a sufficient level of CO₂ capture has been, achieved. It is essential that the CO₂ enriched retentate stream enters the first cryogenic separation stage of the CO₂ condensation plant (and the hydrogen enriched vapour stream(s) enters each subsequent cryogenic separation stage of the CO₂ condensation plant) at a pressure below the cricondenbar for the multicomponent composition(s) otherwise the streams cannot become two phase on cooling (the cricondenbar is the highest pressure at which two phases can coexist). It is also essential that the CO₂ enriched retentate stream (and the hydrogen enriched vapour stream(s)) are not cooled to below their bubble points otherwise the streams will not become two phase. Generally, propane is used as refrigerant in one or more cryogenic separation stages followed by the use of ethane and/or ethylene as refrigerant in one or more further cryogenic separation stages, depending on the desired condensation temperatures in the different cryogenic separation stages. However, other refrigerants may be used such as ammonia, hydrochlorofluorocarbons (HCFC's) and mixed refrigerants. Typical mixed refrigerants comprises at least two refrigerants selected from the group consisting of butanes, propanes, ethane, and ethylene.

The liquid CO₂ streams that are withdrawn from the separation vessels of the CO₂ condensation plant are combined and passed to a pump that increases the pressure of the combined liquid CO₂ stream such that the CO₂ enters the dense phase for transportation.

The H₂ enriched vapour stream that is separated in the last cryogenic separation stage of the series comprises predominantly hydrogen and a small amount of CO₂ (generally at least 98 mol % hydrogen, preferably, at least 99 mole % hydrogen). This H₂ enriched vapour stream is at a high pressure (typically, approximately 46 barg) as pressure drops across the cryogenic separation stages are to be avoided. This ensures that the H₂ enriched vapour stream is obtained at a pressure substantially above the inlet pressure for the combustor of the gas turbine(s) of the Power Island. Accordingly, the hydrogen enriched vapour stream is expanded in an expander down to the inlet pressure of the gas turbines (GTs) of the Power Island. The expansion energy recovered from the H₂ enriched vapour stream in the expander can be converted into electrical power for export or for use within the plant (e.g. to drive the CO₂ pumps). The expanded hydrogen stream is then combined with the hydrogen enriched permeate stream from the Low Temperature H₂ Selective Membrane separation unit before being sent to a Fuel Gas Saturation and Dilution Stage (saturation tower) where the combined stream is further diluted with steam and optionally nitrogen thereby generating a fuel stream comprising approximately 50 mol % hydrogen. Dilution of the fuel stream is required in order to control NOₓ emissions and flame speeds. The fuel stream is then sent to the Power Island, where the fuel is combusted in air in the combustor of at least one modified gas turbine (GT). The GT can be used to drive an electric motor thereby generating electricity. The exhaust gas from the gas turbine is passed to a Heat Recovery Steam Generator (HRSG) where the exhaust gas is heat exchanged with boiler feed water thereby generating steam or with steam to generate superheated steam. Typically, three levels of steam (HP, MP or LP) can be generated from boiler feed water. The resulting steam streams may be combined with the petroleum coke or coal that is fed to the gasifier and/or may be used in a steam turbine that drives an electric generator thereby producing additional electricity. The exhaust gas from the HRSG is vented to atmosphere.

FIGS. 2A/2B show a detailed process flow diagram for the hydrogen selective membrane separation unit and the CO₂ condensation plant of the block diagram outlined in FIGS. 1A/1B. A shifted synthesis gas stream 1 is fed at a pressure of at least 50 barg to at least one membrane separation unit M-1, preferably a plurality of membrane separation units arranged in parallel. The membrane separation unit(s) M-1 are provided with a hydrogen selective membrane that is capable of a bulk separation of a hydrogen enriched permeate stream 3 from a CO₂ enriched retentate stream 2. Where the shifted synthesis gas is derived from a high pressure gasifier, the synthesis gas may be obtained at above the desired operating pressure for the membrane separation unit(s) of at least 50 barg. Where the shifted synthesis gas is derived from a reformer, it may be necessary to boost the pressure to at least 50 barg. Typically, the temperature of the shifted synthesis gas stream 1 is in the range of 30 to 40° C.

The shifted synthesis gas stream 1 comprises hydrogen (for example, 50 to 60 mol %, typically 55 mol %), carbon dioxide (for example, 40 to 50 mol %, typically 45 mol %), and contaminants such as water, inerts (for example nitrogen and/or argon), methane and carbon monoxide. Where the shifted synthesis gas stream is from a high pressure coal or petroleum coke gasifier, it may be a sour shifted synthesis gas stream comprising hydrogen sulfide (0.2 to 1.5 mol %, typically about 1 mol %). However, it is also envisaged that hydrogen sulfide may have been removed from the shifted synthesis gas stream 1 upstream of the membrane separation unit(s) M-1. Where the shifted synthesis gas stream is derived from a reformer, hydrogen sulfide will have been removed from the feed to the reformer so as to avoid poisoning the reforming catalyst. Accordingly, the shifted synthesis gas stream will not contain any hydrogen sulfide impurity.

The membrane that is employed in the membrane separation unit(s) M-1 has a H₂ selectivity (over CO₂) of 16, in order to prevent significant quantities of CO₂ from entering the hydrogen enriched stream 3 as this will reduce the carbon capture level. Preferably the hydrogen selectivity of the membrane is greater than 20, in particular greater than 40.

Optionally, a sweep gas may be introduced to the membrane separation units at the permeate side of the membrane in order to reduce the partial pressure of hydrogen in the permeate stream (and to minimize the pressure drop across the membrane). This is advantageous as it improves the hydrogen selectivity of the membrane and increases the hydrogen flux through the membrane. The sweep gas may be nitrogen, for example, a nitrogen stream that is produced as a by-product in an Air Supply Unit (ASU) that supplies oxygen to a gasifier or reformer. Alternatively, the sweep gas may be steam.

The hydrogen enriched permeate stream is used as a fuel stream for the combustor of one or more gas turbines. Typically, the hydrogen enriched permeate stream 3 is obtained at a pressure that is at or above the minimum inlet pressure for the combustor of the gas turbine(s) thereby avoiding the need for hydrogen compression, which is energy intensive.

Where hydrogen sulfide is present in the synthesis gas stream 1, a portion of this H₂S will pass through the hydrogen selective membrane together with the hydrogen. Accordingly, the hydrogen enriched permeate stream 3 is passed through a bed of absorbent, such as a zinc oxide bed (C-2) to ensure that any H₂S is removed from the hydrogen enriched permeate stream upstream of the gas turbine (not shown).

Suitably, the retentate stream 2 from the membrane separation unit(s) M-1 has a CO₂ concentration of 70 to 80 mol % (depending of the selectivity of the membrane). Where stream 1 is a sour synthesis gas stream, the CO₂ enriched retentate stream 2 from the membrane is sent on to an Absorption Tower (C-1), where the stream 2 is contacted with a solvent that acts as a selective absorbent for H₂S thereby generating a desulfurised shifted synthesis gas stream 4. Suitable solvents that act as selective absorbent for H₂S include Rectisol™ (methanol) or Selexol™ (a mixture of dimethyl ethers of polyethylene glycol).

The desulfurised shifted stream 4 is sent to a drier (D-1) in order to remove water prior to condensing out the CO₂ in a condensation plant. There are many methods known in the art for the removal of saturated water from a process stream including absorbent beds (for example, molecular sieve beds) and/or an absorption tower that employs triethylene glycol (TEG) as water absorbent. The resulting dehydrated shifted synthesis gas stream 5 enters the CO₂ condensation plant at an elevated pressure of at least 45 barg, typically 46 barg and at ambient temperature, typically 25° C., where it is cooled in EX-1 to a temperature of approximately 2° C. against cold water or another “cold stream”, which maybe a slipstream of liquid CO₂ or a cool gaseous H₂ stream arising downstream of EX-1.

The cooled shifted synthesis gas stream 6 then enters the first of a series of cryogenic separation stages each of which comprises a heat exchanger and separator vessel. The separator vessels (V-1 to V-7) are operated at substantially the same pressure but at successively lower temperatures. In heat exchanger EX-2, the cooled synthesis stream 6 is further cooled to a temperature of −4° C. against propane refrigerant to generate a two phase stream 7 which is then passed to separator vessel V-1 where a portion of the CO₂ in stream 7 separates as a liquid phase from a vapour phase. A vapour stream 8 that is enriched in hydrogen and depleted in CO₂ is removed overhead from separator vessel V-1 and is passed through heat exchanger EX-3 where it is further cooled against propane refrigerant to a temperature of −10° C. thereby generating a further two phase stream 10 which is passed to separator vessel V-2 where a portion of the CO₂ in stream 10 separates as a liquid phase from a vapour phase. A vapour stream 11 that is further enriched in hydrogen is withdrawn overhead from separator vessel V-2 and is passed through heat exchanger EX-4 where this stream is further cooled to a temperature of −16° C. against propane refrigerant thereby generating a two phase stream 13 that is passed to separator vessel V-3 where a portion of the CO₂ in stream 13 separates as a liquid phase from a vapour phase. A vapour stream 14 that is further enriched in hydrogen is withdrawn overhead from separator vessel V-3 and is passed through heat exchanger EX-5 where this stream is further cooled to a temperature of −22° C. against propane refrigerant thereby generating a further two phase stream that is passed to separator vessel V-4 where a portion of the CO₂ in this stream separates as a liquid phase from a vapour phase. A vapour stream 16 that is further enriched in hydrogen is withdrawn overhead from separator vessel V-4 and is passed through heat exchanger EX-6 where this stream is further cooled to a temperature of −28° C. against propane refrigerant thereby generating a further two phase stream 18 that is passed to separator vessel V-5 where a portion of the CO₂ in stream 18 separates as a liquid phase from a vapour phase. A vapour stream 19 that is further enriched in hydrogen is withdrawn overhead from separator vessel V-5 and is passed through heat exchanger EX-7 where this stream is further cooled to a temperature of −34° C. against ethane refrigerant thereby generating a further two phase stream that is passed to separator vessel V-6 where a portion of the CO₂ in this stream separates as a liquid phase from a vapour phase. A vapour stream 21 that is further enriched in H₂ is withdrawn overhead from separator vessel V-6 and is passed through heat exchanger EX-8 where this stream is further cooled to a temperature of −50° C. against ethane refrigerant thereby generating a final two phase stream 23 that is passed to separator vessel V-7 where a final portion of the CO₂ separates as a liquid phase from a vapour phase. A non-condensable stream 24 comprising at least 98% H₂ is withdrawn overhead from separator vessel V-7. This non-condensable stream 24 is heated in a heater EX-9 to generate stream 26 before being expanded to lower pressure in expander EXP-1 thereby generating hydrogen stream 27. Suitably, the expander EXP-1 is connected to a motor to recover energy. The H₂ stream 27 is mixed with the membrane permeate stream 33 thereby generating hydrogen fuel stream 34 that is sent to the combustor of at least one gas turbine (not shown) for generation of electricity. The pressure of the hydrogen fuel stream 34 is above the operating pressure of the combustor of the gas turbine thereby allowing the omission of a hydrogen compressor.

The propane refrigerant that is fed to the shell side of heat exchangers EX-2, EX-3, EX-4, EX-5 and EX-6 (and the ethane refrigerant that is fed to the shell side of heat exchangers EX-7 and EX-8) is at successively lower temperatures and may be obtained using any cryogenic method known to the person skilled in the art, including cryogenic methods for producing refrigerants for liquefying natural gas. The ethane refrigerant for heat exchangers EX-7 and EX-8 may be replaced with ethylene. In addition, the refrigerant for each of the heat exchangers EX-2 to EX-8 may be replaced with a mixed refrigerant stream comprising at least two refrigerants selected from the group consisting of butanes, propanes, ethane and ethylene. The composition of the mixed refrigerant streams that are fed to the different heat exchangers may be adjusted to achieve the desired level of cooling.

Although the process of the invention has been described with respect to 7 cryogenic separation stages, the number of cryogenic separation stages may be increased or decreased depending predominantly on the desired level of carbon capture, energy efficiency targets and the capital cost requirements. At least 1 cryogenic separation stage is required, preferably, at least 2. Where there is a single cryogenic separation stage, ethane and/or ethylene is used as the refrigerant in the heat exchanger. However, a single cryogenic separation stage with ethane and/or ethylene as refrigerant would be inefficient in terms of refrigeration power requirements. Accordingly, the number of cryogenic separation stages is preferably at least 2, more preferably 3 to 10, in particular, 5 to 8 in order to optimise the refrigeration power requirements (for the refrigerant compression). However, there is a limit on the lowest temperature in the last stage of separation, as the temperature must be maintained above a value where solid CO₂ will form. This typically occurs at a temperature of −56° C. (the triple point for pure CO₂ is at 5.18 bar and at a temperature of 56.4° C.) although the presence of H₂ may depress this freezing point.

The liquid CO₂ streams 9, 12, 15, 17, 20, 22 and 25 from the flash drums V-1, V-2, V-3, V-4, V-5, V-6, and V-7 respectively are at substantially the same pressure and are mixed to generate a combined stream 28 that is sent to a hold-up tank V-8. A liquid CO₂ stream 30 is withdrawn from the bottom of hold up tank V-8 and is sent to a CO₂ pump (P-1). The CO₂ pump P-1 increases the pressure of the CO₂ such that the CO₂ is in a dense phase (the transition to a dense phase occurs at approximately 80 barg) and then to the pipeline export pressure, of approximately 130 to 200 barg. It may be necessary to heat the dense phase CO₂ prior to it entering the CO₂ export pipeline, in order to meet pipeline design requirements, for example, a side stream from the dense phase CO₂ stream 31 may be used to cool the synthesis gas stream 5 in cross exchanger (EX-1) before being recombined with the dense phase CO₂.

FIGS. 3A/3B/3C/3D illustrate an improvement of the flow scheme of FIGS. 2A/2B. Shifted synthesis gas stream 1, leaving the Low Temperature Gas Cooler (LTGC), is first sent to H₂S Absorption Unit C-101 where the H₂S is removed from the shifted synthesis gas stream. The desulfurised shifted synthesis gas stream 2 is then fed to the membrane separation unit M-101 at a pressure of at least 50 barg, thereby forming a hydrogen enriched permeate stream 3 and a carbon dioxide enriched retentate stream 4. The membrane separation unit M-101 is operated using nitrogen sweep gas to ensure that the hydrogen enriched permeate stream is obtained at the required fuel gas feed pressure for the combustor of the gas turbine(s) of the Power Island (not shown) thereby avoiding the need for a hydrogen compressor. The sweep gas also dilutes the hydrogen content of the hydrogen enriched permeate stream thereby minimizing the need for adding nitrogen diluent to the Fuel Gas stream 31 (see below).

The CO₂ enriched retentate stream is obtained at a pressure substantially ab ove the required fuel gas feed pressure. The CO₂ enriched retentate stream is passed to gas dehydration unit D-500 that removes moisture from the retentate stream thereby preventing moisture from freezing in the downstream cryogenic equipment of the CO₂ Condensation Plant. The gas dehydration unit D-500 comprises a plurality of beds of molecular sieve driers (not shown), for example, two or three beds of molecular sieve driers. Where there are three beds of molecular sieve driers, typically two beds are operated in parallel in adsorption mode and one bed is operated in regeneration mode. Each molecular sieve bed cycles consecutively through adsorption, heating, and cooling modes under control of a sequence control system (not shown). During the adsorption phase, gas flows downwardly through the bed; during the heating and cooling regeneration phases, gas flows upwardly through the bed. The dried gas that leaves the molecular sieve driers when they are operated in adsorption mode is routed through a dried gas filter (not shown) to remove molecular sieve fines from the gas and is then sent to the CO₂ Condensation Plant. A slipstream (not shown) of the dehydrated gas is used as regeneration gas for regenerating the beds of water-loaded molecular sieve driers. The slipstream is routed through a regeneration-gas heater (not shown) and subsequently through the bed in regeneration mode. Typically, the slipstream is heated to a temperature of at least 320° C. (maximum temperature of 350° C.), via a Waste Heat Recovery Unit (WHRU) in the turbine exhaust stack of the Power Island (not shown). The flow rate of the regeneration gas is held constant and temperature control of this gas stream is achieved by operating a by-pass stream around the regeneration gas heater. The heated regeneration gas stream is passed upwardly through the molecular sieve bed in regeneration mode, thereby driving the water from the molecular sieve. After passing through the bed in regeneration mode, the regeneration gas is subsequently cooled by a regeneration gas cooler such as an Air Cooled Heat Exchanger (ACHE, not shown). Condensed water, and potentially condensed co-adsorbed hydrocarbons, are knocked out in a regeneration gas separator (not shown). The gas leaving the regeneration gas separator is compressed by a regeneration gas compressor (not shown) and is combined with the dehydrated CO₂ enriched gas stream 5 upstream of the dehydration unit D-500.

The, dried CO₂ enriched retentate stream 5 is passed to the CO₂ Condensation Plant that comprises a Pre-Cooler Heat Exchanger E-101 upstream of a CO₂ Condensation Circuit. The CO₂ Condensation Circuit is comprised of five cryogenic separation stages, each comprising a heat exchanger (kettle) and a gas-liquid separator (knock out separator drum). The operation of the Pre-Cooler Heat Exchanger E-101 and the CO₂ Condensation Circuit will now be discussed in detail.

The Pre-Cooler Heat Exchanger E-101 is a Plate Fin Heat Exchanger (PFHE) which utilises the energy available from cold product streams including the combined condensed liquid CO₂ stream 25, the cold Fuel Gas stream 20 and the Fuel Gas Expander Outlet stream 23 (discussed below), to pre-cool the dried CO₂ enriched retentate stream 5 prior to entry to the CO₂ Condensation Circuit. The pre-cooled CO₂ enriched retentate stream 6 that exits Pre-Cooler Heat Exchanger E-101 is routed to the tube-side of kettle E-102 of the first cryogenic separation stage of the CO₂ Condensation Circuit, where it is cooled against evaporating high pressure propane (HP-C3) refrigerant to a temperature of −7.8° C. and the resulting two-phase stream is separated in Knock Out Separator Drum V-102. A liquid CO₂ stream 9 and a hydrogen enriched vapour stream are withdrawn from the bottom and top of the Knock Out Separator Drum V-102 respectively. The vapour stream 8 is sent to the second cryogenic separation stage where the hydrogen enriched vapour stream is cooled in kettle E-103 against medium pressure propane (MP-C3) refrigerant to a temperature of −17.5° C. and the resulting two phase stream is separated in Knock Out Separator Drum V-103. A liquid CO₂ stream 12 and a vapour stream 11 that is further enriched in hydrogen are withdrawn from the bottom and top of Knock Out SeparatorDrum V-103 respectively. The vapour stream 11 is passed to the third cryogenic separation stage where it is cooled in kettle E-104 against a low pressure propane (LP-C3) refrigerant to a temperature of −29.7° C. and the resulting two phase stream is separated in Knock Out Separator Drum V-104. A liquid CO₂ stream 15 and a vapour stream 14 that is further enriched in hydrogen are withdrawn from the bottom and top of V-104 respectively. Vapour stream 14 is passed to the fourth cryogenic separation stage where it is cooled in kettle E-105 against high pressure ethane (HP-C2) refrigerant to a temperature of −40.8° C. and the resulting two phase stream is separated in Knock Out Separator Drum V-105 thereby generating liquid CO₂ stream 18 and a vapour stream 17 that is further enriched in hydrogen. Vapour stream 17 is then passed to the fifth separation stage where it is cooled in kettle E-106 against low pressure ethane (LP-C2) refrigerant to a temperature of −50° C. The resulting two phase stream is separated in Knock Out Separator Drum V-106 thereby generating liquid CO₂ stream 21 and a hydrogen enriched vapour stream 20 (Fuel Gas). The cryogenic separation stages are operated with minimum pressure drop across the stages such that the Fuel Gas stream 20 is obtained at a pressure substantially above the fuel gas entry specification of 30 bara (inlet pressure for the combustor(s) of the gas turbine(s) of the Power Island). Accordingly, the Fuel Gas stream 20 is routed via Pre-Cooler Heat Exchanger E-101 to Fuel Gas Expander K-101, where the Fuel Gas stream is reduced in pressure to meet the fuel gas entry specification and the expansion energy is extracted as electricity to enhance the efficiency of the process. The outlet stream 23 from the Fuel Gas Expander K-101 is passed through Pre-Cooler Heat Exchanger E-101 and the Fuel Gas stream 24 that exits E-101 is routed to a fuel gas manifold (not shown).

The liquid CO₂ streams 9, 12, 15, 18 and 21 from the cryogenic separation stages are routed to a manifold (not shown) where they are combined to form combined liquid CO₂ stream 25 that is sent to Pre-Cooler Heat Exchanger E-101 for cold recovery. The liquid CO₂ stream 26 that exits the Pre-Cooler E-101 is then passed to CO₂ Surge Control Drum V-101. A liquid CO₂ stream 28 (comprising greater than 98 mole % CO₂) is removed from the bottom of CO₂ Surge Control Drum V-101 and is routed to the CO₂ Product Pumps P-101 A/F and is discharged to the CO₂ Pipeline via line 29 at an entry pressure of 137 bara. A hydrogen enriched vapour stream may be withdrawn overhead from the CO₂ Surge Control Drum V-101 via lines 27 and 27A and is combined with Fuel Gas stream 24 thereby generating stream 30. Stream 30 is then combined with hydrogen enriched permeate stream 3 (from the membrane separation unit) thereby generating stream 31. Alternatively, streams 24, 27A, and 3 can be combined using a manifold to form stream 31 thereby omitting stream 30. The combined stream 31 is diluted with medium pressure steam (MPS) to a hydrogen concentration of 50 mole % thereby forming diluted Fuel Stream 32. The diluted Fuel Stream 32 is fed at a pressure of 30 bara to a Fuel Gas Heater E-401, that heats Fuel Stream 32 to a temperature of 275° C. thereby generating heated Fuel Gas Stream 33 which is routed to the Power Island (not shown).

The propane refrigerant in the CO₂ Condensation Circuit is compressed in four stages by a centrifugal compressor K-301, as shown in FIG. 3C. Compressor K-301 comprises low pressure (LP), medium pressure (MP), high pressure (HP) and ultra-high pressure (HHP) stages. To reduce the flare load the compressor has its own recycle with air cooling (desuperheater) and its own safety facilities.

Propane vapour stream 301 from the compressor K-301 discharge is desuperheated in the air cooled Desuperheater E-301 and is then fully condensed in air cooled Condenser E-302. The liquefied propane 305 is collected in a horizontal propane receiver, V-301. A condensed propane liquid stream 306 is withdrawn from the bottom of V-301 and is routed to the kettles E-102, E-103 and E-104 of the first, second and third cryogenic separation stages respectively and to the ethane refrigerant circuit condenser E-201. These kettles are arranged in a cascading series. In order to minimise the degree of flashed propane vapours entering the HP-C3 kettle E-102, the condensed propane is let down to a HHP Propane Economiser V-302 whereby the vapour stream 308 exiting the top of V-302 is routed to the propane compressor K-301 via propane compressor HHP suction drum V-306 and the liquid stream 309 exiting the bottom of V-302 is cascaded to the HP-C3 kettle E-102.

All propane flows to the HP-C3 kettle E-102, MP-C3 kettle E-103 and LP-C3 kettle E-104 are controlled by means of their respective inlet level control valves. Vapour exiting the kettles is combined and routed to the propane compressor K-301 at their relevant pressure levels via their respective suction knockout vessels, i.e. HP propane suction drum V-305, MP propane suction drum V-304 and LP propane suction drum V-303.

The Ethane refrigerant in the CO₂ Condensation Circuit is compressed in two stages by centrifugal compressors, HP Ethane Compressor K-201 and LP Ethane Compressor K-202 that operate on a common shaft, as shown in FIG. 3D. Ethane vapour streams 210 and 216 from the discharge of the compressors is combined to form stream 201 that is fully condensed against propane refrigerant in Ethane Condenser E-201. The liquefied ethane stream 204 exiting E-201 is then collected in a horizontal ethane receiver, V-201. The discharge pressure of the compressors is governed by the condensing pressure at the exit of the Ethane Condenser E-201.

The condensed ethane liquid (stream 205) is routed to the heat exchangers (kettles) E-105 and E-106 of the fourth and fifth cryogenic separation stages in the HP and LP ethane circuit loops respectively. For the HP ethane circuit loop, ethane flow to kettle E-105 is controlled by means of an inlet level control valve. The vapour stream 208 exiting the E-105 kettle is routed to the HP Ethane compressor K-201 via the HP ethane suction drum V-202. For the LP ethane circuit loop, ethane flow is via an Ethane Economiser E-202 to the E-106 kettle, again controlled by means of a kettle inlet level control valve. The vapour stream 213 exiting the E-105 kettle is routed to the LP Ethane compressor K-202 via the Ethane Economiser E-202, to recover the cooling duty, and a LP ethane suction drum V-203.

FIGS. 4A/4B illustrate a block flow diagram for a modified scheme that will be described by reference to both FIGS. 1A/1B and 2A/2B. FIGS. 4A/4B is identical to FIGS. 1A/1B upstream of the CO₂ condensation plant. In the modified scheme of FIGS. 4A/4B, the enriched CO₂ retentate stream is passed through a series of 5 cryogenic separation stages that employ propane as refrigerant (with the cryogenic separation stages operated at the same temperatures as described for FIGS. 2A/2B). Thus, separator vessel V-5 is operated at a temperature of −28° C. The vapour stream that is withdrawn from separator vessel V-5 is sufficiently enriched in H₂ that it may be used as feed to a membrane separation unit that separates a H₂ enriched permeate stream from a CO₂ enriched retentate stream. Nitrogen may be added as sweep gas to the permeate stream. Depending upon the operating temperature of the hydrogen selective membrane, it may be necessary to warm the H₂ enriched vapour stream that is withdrawn from separator vessel V-5 prior to this stream entering the membrane separation unit. It may also be necessary to cool the CO₂ enriched retentate stream against a cold stream (for example, cold water) as described for the CO₂ enriched stream 5 of FIGS. 2A/2B. The CO₂ enriched stream is then passed through a further heat exchanger that employs propane as refrigerant and cools the CO₂ enriched stream to a temperature of −22° C. thereby generating a two phase stream that is separated into a liquid CO₂ stream and a vapour stream in a further separator vessel. Thus, the presence of the membrane separation unit within the CO₂ condensation plant allows the plant to operate using only propane as refrigerant. In addition, the scheme of FIGS. 4A/4B reduces the number of cryogenic separation stages. The hydrogen permeate stream from the second membrane separation unit that is within the CO₂ condensation plant is mixed with the hydrogen from the first membrane separation unit prior to entering the zinc oxide beds. The resulting desulfurised stream is then blended with the hydrogen enriched stream from the final cryogenic separation stage of CO₂ condensation plant. The liquid CO₂ streams from the separator vessels of the CO₂ condensation plant (separator vessels V-1, V-2, V-3, V-4 and V-5 and the further separator vessel after the membrane separation unit) are combined and the combined liquid CO₂ stream is passed to the CO₂ pump, as described in FIGS. 2A/2B.

FIGS. 5A/5B is identical to FIGS. 1A/1B upstream of the CO₂ condensation plant. In the modified scheme of FIGS. 5A/5B, the enriched CO₂ stream is subjected to a first cryogenic separation stage that employs propane as refrigerant and cools the enriched CO₂ stream down to a temperature of −4° C. thereby generating a two phase stream that is separated into a liquid CO₂ stream and a H₂ enriched vapour stream in a first separator vessel. The H₂ enriched vapour stream from this first cryogenic separation stage is passed to a membrane separation unit to separate a H₂ enriched permeate stream from a CO₂ enriched retentate stream. Nitrogen may be added as sweep gas to the permeate stream. Depending upon the operating temperature of the hydrogen selective membrane, it may be necessary to warm the H₂ enriched vapour stream prior to this stream entering the membrane separation unit. The CO₂ enriched retentate stream is then subjected to external refrigeration at a temperature of −50° C. using ethane and/or ethylene as external refrigerant. The membrane separation unit of the CO₂ condensation plant reduces the refrigeration duties of the plant so that the condensation temperature after the second membrane separation unit is approximately −50° C. Accordingly, the scheme of FIGS. 5A/5B reduces the number of cryogenic separation stages. The hydrogen enriched permeate stream from the membrane separation unit of the CO₂ condensation plant is mixed with the hydrogen enriched permeate stream from the first membrane separation unit prior to entering the zinc oxide beds. The resulting desulfurised stream is then blended with the non-condensable stream (hydrogen enriched stream from the final cryogenic separation stage of the CO₂ condensation plant). The liquid CO₂ streams that are withdrawn from the separators of the CO₂ condensation plant are combined and the combined liquid CO₂ stream is pumped to the required transportation pressure as described for FIGS. 2A/2B.

FIG. 6A is identical to FIG. 3A upstream of the CO₂ Condensation Circuit. The CO₂ Condensation Circuit of FIGS. 6A/6B/6C is comprised of three cryogenic separation stages upstream of a membrane separation unit M-102 and two cryogenic separation stages downstream of the membrane separation unit M-102.

The Pre-Cooler Heat Exchanger E-101 is operated as described in FIGS. 3A/3B/3C/3D and utilises the energy available from cold product streams including the combined condensed liquid CO₂ stream 30, the cold Fuel Gas stream 25 and the Fuel Gas Expander Outlet stream 28 (discussed below); to pre-cool the dried CO₂ enriched retentate stream 5 prior to entry to the CO₂ Condensation Circuit. The pre-cooled CO₂ enriched retentate stream 6 that exits Pre-Cooler Heat Exchanger E-101 is routed to the CO₂ Condensation Circuit, where the first, second and third cryogenic separation stages upstream of the membrane separation unit M-102 are operated in an identical manner to the first, second and third cryogenic separation stages of FIGS. 3A/3B/3C/3D. The hydrogen enriched vapour stream that is withdrawn from the Knock Out Separation Drum, V-104, of the third cryogenic separation stage is then pre-heated in heat exchanger E-110 against a CO₂ enriched retentate stream 18 that is produced in membrane separation unit M-102. The pre-heated vapour stream 16 is then further heated in heat exchanger E-120 against medium pressure stream (MPS) to a temperature of 25° C. and the heated stream 17 is fed to the membrane separation unit M-102 thereby forming a hydrogen enriched permeate stream 19 and a carbon dioxide enriched retentate stream 18. The membrane separation unit M-102 is operated using nitrogen sweep gas.

As discussed above, the carbon dioxide enriched permeate stream 18 is heat exchanged against vapour stream 14 in pre-heater E-110 and the resulting cooled carbon dioxide enriched permeate stream 20 is passed to the fourth cryogenic separation stage where it is cooled in kettle E-105 against medium pressure propane (MP-C3) refrigerant to a temperature of −17.5° C. and the resulting two phase stream is separated in Knock Out Separator Drum V-105 thereby generating liquid CO₂ stream 23 and a vapour stream 22 that is further enriched in hydrogen. Vapour stream 22 is then passed to the fifth separation stage where it is cooled in kettle E-106 against low pressure propane (LP-C3) refrigerant to a temperature of −29.7° C. The resulting two phase stream is separated in Knock Out Separator Drum V-106 thereby generating liquid CO₂ stream 26 and a Fuel Gas stream 25. The Fuel Gas stream 25 is routed via Pre-Cooler Heat Exchanger E-101 to the Fuel Gas Expander K-101, where the Fuel Gas stream is reduced in pressure to meet a fuel gas entry specification of 30 bara and the expansion energy is extracted as electricity to enhance the efficiency of the process. The outlet stream 28 from the Fuel Gas Expander K-101 is passed through Pre-Cooler Heat Exchanger E-101 and the outlet stream 29 from E-101 is then routed to a Fuel Gas manifold (not shown).

The liquid CO₂ streams 9, 12, 15, 23 and 26 from the cryogenic separation stages are routed to a manifold (not shown) where they are combined to form combined liquid CO₂ stream 30 that is sent to Pre-Cooler Heat Exchanger E-101 for cold recovery. The liquid CO₂ stream 31 that exits the Pre-Cooler E401 is then passed to CO₂ Surge Control Drum V-101. A liquid CO₂ stream 33 (comprising greater than 98 mole % CO₂) is removed from the bottom of CO₂ Surge Control Drum V-101 and is routed to the CO₂ Product Pumps P-101 A/F and is discharged to the CO₂ Pipeline via line 34 at an entry pressure of 137 bara. A vapour stream 32 may be withdrawn overhead from the CO₂ Surge Control Drum V-101 via lines 32 and 32A and is combined with the hydrogen enriched Fuel Gas stream 29 thereby forming stream 35. Stream 35 is then combined with the H₂ enriched permeate streams 3 and 19 from membrane separation units M-101 and M-102 respectively. The resulting combined stream 36 is diluted with medium pressure steam (MPS) to a hydrogen concentration of 50 mole % thereby forming diluted Fuel Stream 37. The diluted Fuel Stream 37 is then fed at a pressure of 30 bara to a Fuel Gas Heater E-401, that heats the diluted Fuel Stream 37 to a temperature of 275° C. thereby generating heated Fuel Stream 38 which is routed to the Power Island (not shown).

The propane refrigerant in the circuit is compressed in four stages by a centrifugal compressor K-301, as described in FIG. 6C. Compressor K-301 comprises low pressure (LP), medium pressure (MP), high pressure (HP) and ultra-high pressure (HHP) stages. To reduce the flare load the compressor has its own recycle with air cooling (desuperheater) and its own safety facilities. Propane vapour stream 301 from the compressor K-301 discharge is desuperheated in the air cooled Desuperheater E-301 and is then fully condensed in air cooled Condenser E-302. The liquefied propane stream 305 is collected in a horizontal propane receiver, V-301. A condensed propane liquid stream 306 is withdrawn from the bottom of V-301 and is routed to the kettles E-102, E-103, and E-104 of the first, second and third cryogenic separation stages respectively and to kettles E-105 and E-106 of the fourth and fifth cryogenic separation stages respectively. In order to minimise the degree of flashed propane vapours entering the HP-C3 kettle E-102, the condensed propane is let down to a HHP Propane Economiser V-302 whereby the vapour stream 308 exiting V-302 is routed to propane compressor K-301 via HHP suction drum V-306 and the liquid stream 309 exiting V-302 is cascaded to the HP-C3 kettle E-102. From the HP-C3 kettle E-102, the liquid propane stream 319 is cascaded to the MP-C3 kettles E-103 and E-105. The liquid propane stream 329 from the MP-C3 E-103 kettle is cascaded to the LP-C3 E-104 kettle while the liquid propane stream 349 from the MP-C3 E-105 kettle is cascaded to the LP-C3 E-106 kettle.

All propane flows to the HP-C3 kettle E-102, the MP-C3 kettles E-103 and E105 and the LP-C3 kettles E-104 and E-106 are controlled by means of their respective inlet level control valves. Vapour stream 318 exiting the HP-C3 kettle E-102 is routed to the propane compressor K-301 via HP propane suction drum, V-305. Vapour streams 326 and 327 exiting the MP-C3 kettles E-103 and E-105 respectively are combined and the combined vapour stream 328 is routed to the propane compressor K-301 via MP propane suction drum, V-304. Vapour streams 336 and 351 exiting the LP-C3 kettles E-104 and E-105 respectively are combined and the combined vapour stream 338 is routed to the propane compressor K-310 via LP propane suction drum V-303.

An advantage of the process scheme of FIGS. 6A/6B/6C is that the refrigeration system employs a single external refrigerant (propane) thereby eliminating the requirement for an ethane and/or ethylene refrigerant.

1. A process for (a) separating a synthesis gas stream into a hydrogen enriched vapour stream and a liquid carbon dioxide stream, (b) generating electricity from the separated hydrogen enriched stream by feeding the separated hydrogen enriched stream as a fuel gas stream to a combustor of at least one gas turbine of a power plant, and (c) sequestrating the liquid carbon dioxide stream, characterised in that said process comprises:
(A) (a) feeding a shifted synthesis gas stream at a pressure of at least 50 bar gauge to at least one membrane separator unit that is provided with membrane having a selectivity for H₂ over CO₂ of greater than 16; and (b) withdrawing from the membrane separation unit a hydrogen enriched permeate stream having a CO₂ content of 10 mole % or less and a carbon dioxide enriched retentate stream having a CO₂ content of at least 63 mole % CO₂, preferably, at least 70 mole % CO₂ wherein the hydrogen enriched permeate stream and the carbon dioxide enriched retentate stream are each withdrawn from the membrane separation unit at a pressure that is at or above the minimum fuel gas feed pressure for the combustor of the gas turbine(s) of the power plant;
(B) (a) feeding the carbon dioxide enriched retentate stream to a carbon dioxide condensation plant that comprises a first cryogenic separation stage and optionally one or more further cryogenic separation stages wherein the first cryogenic separation stage and the optional further cryogenic separation stage(s) each comprise a heat exchanger and separator vessel; and (b) generating in the carbon dioxide condensation plant a further hydrogen enriched vapour stream having a CO₂ content of 10 mole % or less and at least one liquid stream comprising substantially pure liquid CO₂ by the steps of:
(i) passing the carbon dioxide enriched retentate stream through the heat exchanger of the first cryogenic separation stage where the retentate stream is cooled against an external refrigerant to below its dew point thereby forming a cooled stream comprising a liquid phase and a vapour phase wherein the liquid phase comprises substantially pure liquid CO₂ and the vapour phase is enriched in hydrogen compared with the retentate stream;
(ii) passing the two-phase stream from step (i) to the separator vessel of the first cryogenic separation stage where the liquid phase is separated from the vapour phase;
(iii) withdrawing a liquid CO₂ stream and a hydrogen enriched vapour stream from the separator vessel of the first cryogenic separation stage;
(iv) if the CO₂ content of the hydrogen enriched vapour stream is above 10 mole %, passing the hydrogen enriched vapour stream through the heat exchanger of a further cryogenic separation stage where the vapour stream is cooled against a further external refrigerant to below its dew point thereby forming a further cooled stream comprising a liquid phase and a vapour phase wherein the liquid phase comprises substantially pure liquid CO₂ and the vapour phase is further enriched in hydrogen compared with the retentate stream;
(v) passing the two-phase stream from step (iv) to the separator vessel of the further cryogenic separation stage where the liquid phase is separated from the vapour phase;
(vi) withdrawing a liquid CO₂ stream and a hydrogen enriched vapour stream from the separator vessel of the further cryogenic separation stage; and
(vii) if necessary, repeating steps (iv) to (vi) by passing the hydrogen enriched vapour stream through one or more further cryogenic separation stages until the CO₂ content of the hydrogen enriched vapour stream that is withdrawn from the separator vessel of the further cryogenic separation stage is 10 mole % or less,
wherein any pressure drop across the cryogenic separation stage(s) is controlled such that the further hydrogen enriched vapour stream having a carbon dioxide content of 10 mole % or less is obtained at a pressure that is at or above the minimum fuel gas feed pressure for the combustor of the gas turbine(s) of the power plant;
(C) passing the hydrogen enriched vapour stream having a CO₂ content of less than 10 mole % that is formed in step (A) and/or the hydrogen enriched permeate stream having a CO₂ content of less than 10 mole % that is formed in step (B) as a fuel gas feed stream to the combustor(s) of the gas turbine(s) of the power plant for the production of electricity; and
(D) sequestering the liquid CO₂ stream(s) formed in step (B).

2. A process as claimed in claim 1 wherein a sweep gas comprising nitrogen and/or steam is fed to the permeate side of the membrane of the membrane separation unit.

3. A process as claimed in claim 1 wherein the shifted synthesis gas stream is fed to the membrane separation unit(s) at a temperature in the range of 0 to 50° C., preferably, 20 to 40° C. and the membrane separation unit is provided with a hydrogen selective membrane that is capable of operating at the temperature of the shifted synthesis gas feed stream.

4. A process as claimed in claim 3 wherein the hydrogen selective membrane is selected from polybenzimidazole (PBI)-based polymeric membranes comprising a PBI-based polymeric selective layer coated onto a porous metallic substrate, a porous metallic substrate or a porous polymeric substrate.

5. A process as claimed in claim 3 wherein the shifted synthesis gas stream is cooled upstream of the membrane separation unit(s) to below its dew point thereby forming a condensate comprising water and the condensate is separated from the cooled shifted synthesis gas stream.

6. A process as claimed in claim 1 wherein the shifted synthesis gas stream is fed to the membrane separator unit(s) at a temperature in the range of 75 to 400° C., preferably, 100 to 300° C. and wherein the CO₂ enriched retentate stream that is removed from the membrane separation unit(s) is cooled downstream of the membrane separation unit(s) before the retentate stream enters the CO₂ condensation plant.

7. A process as claimed in claim 6 wherein the shifted synthesis gas stream that is fed to the membrane separator unit(s) comprises steam and wherein a condensate comprising water is separated from the cooled CO₂ enriched retentate stream before the retentate stream enters the CO₂ condensation plant.

8. A process as claimed in claim 6 wherein, prior to being fed to the membrane separation unit(s), the shifted synthesis gas stream is cooled to below its dew point thereby forming a condensate comprising water that is separated from the shifted synthesis gas stream and the shifted synthesis gas stream is subsequently reheated to a temperature in the range of 75 to 400° C., preferably, 100 to 300° C.

9. A process as claimed in claim 1 wherein the shifted synthesis gas stream is fed to the membrane separator unit(s) at a pressure of at least 60 barg.

10. A process as claimed in claim 1 wherein the H₂ enriched retentate stream is withdrawn from the membrane separation unit(s) at a pressure that is above the operating pressure of the gas turbine(s) of the power plant.

11. A process as claimed in claim 1 wherein the hydrogen selective membrane that is employed in the membrane separator unit(s) has a H₂ selectivity (over CO₂) of greater than 20, preferably, greater than 40.

12. A process as claimed in claim 1 wherein the CO₂ content of the hydrogen enriched permeate stream is less than 2 mole %.

13. A process as claimed in claim 1 wherein the CO₂ content of the CO₂ enriched retentate stream is in the range of 70 to 85 mole %.

14. A process as claimed in claim 1 wherein the CO₂ enriched retentate stream is passed to a pre-cooling heat exchanger of the CO₂ condensation plant where the retentate stream is pre-cooled to a temperature in the range of 0 to 10° C.

15. A process as claimed in claim 1 wherein the CO₂ condensation plant comprises a plurality of cryogenic separation stages that are arranged in series, the CO₂ enriched retentate stream is fed to the first cryogenic separation stage in the series, and the hydrogen enriched vapour stream having a CO₂ content of less than 10 mole % is withdrawn from the final cryogenic stage in the series.

16. A process as claimed in claim 15 wherein the CO₂ condensation plant comprises 4 to 8 cryogenic separation stages arranged in series.

17. A process as claimed in claim 1 wherein the external refrigerant is selected from propane, ethane, ethylene, ammonia, hydrochlorofluorocarbons (HCFC's) and mixed refrigerants comprising at least two refrigerants selected from the group consisting of butanes, propanes, ethane, and ethylene.

18. A process as claimed in claim 15 wherein the H₂ enriched vapour stream that is withdrawn from the separator vessel of an intermediate cryogenic separation stage has a H₂ content of at least 40 mole %, preferably, at least 50 mole % and this H₂ enriched vapour stream is passed to a membrane separation unit of the CO₂ condensation plant where a hydrogen selective membrane is used to separate a hydrogen enriched permeate stream from a CO₂ enriched retentate stream; and the CO₂ enriched retentate stream from the membrane separation unit of the CO₂ condensation plant is used as feed to at least one further cryogenic separation stage of the CO₂ condensation plant.

19. A process as claimed in claim 15 wherein the hydrogen enriched vapour stream (non-condensable stream) from the final cryogenic separation stage of the CO₂ condensation plant comprises at least 90 mole % hydrogen, preferably, at least 95 % hydrogen, more preferably, at least 98 mole % hydrogen, in particular, at least 99 mole % hydrogen.

20. A process for separating a synthesis gas stream into a hydrogen enriched vapour stream and a liquid carbon dioxide stream, the process comprising:
(A) (a) feeding a shifted synthesis gas stream at a pressure of at least 50 bar gauge to at least one membrane separator unit that is provided with membrane having a selectivity for H₂ over CO_{Q} of greater than 16: and
(b) withdrawing from the membrane separation unit a hydrogen enriched permeate stream having a CO₂ content of 10 mole % or less and a carbon dioxide enriched retentate stream having a CO₂content of at least 63 mole % CO₂ wherein the hydrogen enriched permeate stream and the carbon dioxide enriched retentate stream are each withdrawn from the membrane separation unit at a pressure that is at or above 25 barg:
(B) (a) feeding the carbon dioxide enriched retentate stream to a carbon dioxide condensation plant that comprises a first cryogenic separation stage and optionally one or more further cryogenic separation stages wherein the first cryogenic separation stage and the optional further cryogenic separation stage(s) each comprise a heat exchanger and separator vessel: and (b) generating in the carbon dioxide condensation plant a further hydrogen enriched vapour stream having a CO₂content of 10 mole % or less and at least one stream comprising substantially pure liquid CO the steps of:
(i) passing the carbon dioxide enriched retentate stream through the heat exchanger of the first cryogenic separation stage where the retentate stream is cooled a against an external refrigerant to below its dew point thereby forming a cooled stream comprising a liquid phase and a vapour phase wherein the liquid phase comprises substantially pure liquid CO₂ and the vapour phase is enriched in hydrogen compared with the retentate stream:
(ii) passing the two-phase stream from step (i) to the separator vessel of the first cryogenic separation stage where the liquid phase is separated from the vapour phase:
(iii) withdrawing a liquid CO₂ stream and a hydrogen enriched vapour stream from the separator vessel of the first cryogenic separation stage:
(iv) if the CO₂content of the hydrogen enriched vapour stream is above 10 mole %, passing the hydrogen enriched vapour stream through the heat exchanger of a further cryogenic separation stage where the vapour stream is cooled against a further external refrigerant to below its dew point thereby forming a further cooled stream comprising a liquid phase and a vapour phase wherein the liquid phase comprises substantially pure liquid CO₂ and the vapour phase is further enriched in hydrogen compared with the retentate stream:
(v) passing the two-phase stream from step (iv) to the separator vessel of the further cryogenic separation stage where the liquid chase is separated from the vapour phase:
(vi) withdrawing a liquid CO₂ stream and a hydrogen enriched vapour stream from the separator vessel of the further cryogenic separation stage: and
(vii) if necessary, repeating steps (iv) to (vi) by passing the hydrogen enriched vapour stream through one or more further cryogenic separation stages until the CO₂ content of the hydrogen enriched vapour stream that is withdrawn from the separator vessel of the further cryogenic separation stage is 10 mole or less,
wherein the further hydrogen enriched vapour stream having a carbon dioxide content of 10 mole % or less is obtained at a pressure that is at or above 25 barg.
